(19) United States
(12) Patent Application Publication
(10) Pub. No.: US 2015/0228066 A1
(43) Pub. Date: Aug. 13, 2015

(54) Rear Encroaching Vehicle Monitoring And Alerting System

(71) Applicant: Michael Scot Farb, Silver City, NM (US)

(72) Inventor: Michael Scot Farb, Silver City, NM (US)

(21) Appl. No.: 14/617,827

(22) Filed: Feb. 9, 2015

Related U.S. Application Data
(60) Provisional application No. 61/938,118, filed on Feb. 10, 2014.
(60) Provisional application No. 61/982,275, filed on Apr. 21, 2014.

(51) Int. Cl. G06T 7/00; H04N 5/225

(52) U.S. Cl. CPC G06T 7/004; H04N 5/2252; G06T 2207/30252

(57) ABSTRACT

A vehicle encroachment warning system comprising at least one rearward oriented sensing circuit for identifying a positional relationship and velocity of an approaching object. The sensing circuit can be a digital image capturing system, such as video. The system integrates a controller functioning as a user interface. The controller provides alerts and other various information to the user. The controller maintains a history of metrics throughout the period of use. An application enabled on a Smartphone can be used as the controller. Features of the Smartphone enhance the system, enabling communication between the system and vehicles in the proximity, automatic dialing to e-911 or others upon sudden motions (such as an impact), etc. The system can employ a single stage sensing system, such as a computer vision analysis or a two stage, using video analysis, then transitioning to a higher resolution system, such as radar.

### RELATED US PATENT APPLICATIONS

This Non-Provisional patent application is a Non-Provisional patent application claiming the benefit of:

U.S. Provisional Patent Application Ser. 61/938,118, filed on Feb. 10, 2014, and

U.S. Provisional Patent Application Ser. 61/982,275, filed on Apr. 21, 2014,

all of which are incorporated by reference in their entireties.

### FIELD OF THE INVENTION

The present disclosure generally relates to an impending collision identification and warning system. More particularly, the present disclosure relates to an application enabled on a Smartphone in conjunction with at least one remote camera to identify when a vehicle is approaching from the rear and when the approaching vehicle is traveling in a direction and rate of speed that suggests an impending collision with the user.

### BACKGROUND OF THE INVENTION

Bicycle riders travel either alone or in groups, alongside or within a, outside lane of traffic. The cyclists travel in the same direction as the flow of traffic, but at a slower rate of speed. In certain, developed areas, roadways include a bicycle or shoulder lane adjacent to an outer lane of travel of a roadway to improve accommodations for both cyclists and motor vehicles. Bicycle riders commonly travel at a rate of speed slower than the surrounding traffic. The rider focuses on the direction of travel, and relies upon awareness and trust of rearwardly approaching drivers. Unfortunately, instances where the approaching vehicle accidentally clips or hits the bicycle and/or bicycle rider occur, resulting in injury or death of the rider.

What is desired is a monitoring system that identifies a vehicle approaching from a rear and/or side, wherein the speed and direction of travel of the approaching vehicle suggests and impending collision between the vehicle employing the monitoring system and the approaching vehicle.

The current state of communication between the cyclist and driver(s) of nearby vehicles is limited to visual gestures by the driver and/or cyclist, vehicle turn signals, brake lights, a vehicle horn, and the like.

What is desired is a system enabling communication between the cyclist and driver(s) of nearby vehicles to reduce or eliminate collisions, reduce or eliminate interference along the paths of travel of either or both vehicles.

### SUMMARY OF THE INVENTION

The general concept is directed towards a monitoring and alerting system that identifies when a vehicle is approaching from the rear and is traveling in a direction and rate of speed that suggests an impending collision with a user. The monitoring and alerting system should be a low cost solution that is portable, self-contained, and lightweight. The monitoring and alerting system would be adaptable for attachment to any of a variety of objects, including a bicycle (or similar) frame, people, clothing, hats, and the like, enabling a variety of applications.

In accordance with one embodiment of the present invention, the invention consists of a monitoring and alerting system including:

A) at least one microprocessor, wherein said microprocessor is operated in accordance with a series of operational instruction sets, said operational instructional sets include:
a detection analysis instruction set, and
a user warning instruction set;

B) an adjacent vehicle location acquisition system in signal communication with the at least one microprocessor; and

C) a user warning system in signal communication with and in operational control from the at least one microprocessor.

In a second aspect, the at least one microprocessor is integrated into a Smartphone.

In another aspect, the Smartphone further comprises a display.

In another aspect, the Smartphone further comprises a digital memory device.

In yet another aspect, the Smartphone further comprises a touch screen display.

In yet another aspect, the Smartphone further comprises at least one communication circuit, wherein the at least one communication circuit is in signal communication with and in operational control from the at least one microprocessor.

In yet another aspect, the at least one communication circuit can include at least one of a cellular communication circuit, a Bluetooth communication circuit, a Wi-Fi communication circuit, a Near Field Communication (NFC) circuit, and the like.

In yet another aspect, the Smartphone further comprises at least one video image capture device, such as a camera.

In yet another aspect, the Smartphone further comprises a pair of video image capture devices, having one video image capture device oriented to capture an image when facing a first side of the Smartphone and a second video image capture device oriented to capture an image when facing a second, opposite side of the Smartphone.

In yet another aspect, the Smartphone further comprises a Global Positioning System (GPS) circuit.

In yet another aspect, the Smartphone further comprises a motion sensing circuit.

In yet another aspect, the Smartphone further comprises a visual alert. The visual alert can be provided through the display; by way of a separate illuminating element, such as an Light Emitting Diode (LED), a laser, and the like; or any other visual alerting mechanism.

In yet another aspect, the Smartphone further comprises an audible alert. The audible alert can be provided through a speaker, a series of speakers, and the like.

In yet another aspect, the Smartphone further comprises a tactile or vibrating alert. The tactile or vibrating alert can be provided by an off balance motor, a pancake motor, a piezoelectric vibrator, and the like.

In yet another aspect, the Smartphone further comprises an emergency 911 auto dialer. The emergency 911 auto dialer can be activated by the user actuating a button or other trigger; a motion sensed by the motion sensing circuit; a collision identified by the camera, motion sensing circuit; and the like.

In yet another aspect, the Smartphone further comprises an interface connector, wherein the interface connector enables signal communication and operational control of at least one external device by the microprocessor.

In yet another aspect, the Smartphone further comprises a portable power supply.

In yet another aspect, the adjacent vehicle location acquisition system employs at least one digital image capture camera.

In yet another aspect, the digital image capture camera is encased in a remote camera housing. A mounting system secures the remote camera housing to a supporting body. The supporting body can be any device, including a manually powered bicycle, a manually powered three-wheeled vehicle or tricycle, a motorized two-wheeled vehicle, a motorized three-wheeled vehicle or trike, a motorized multi-wheeled vehicle, and the like. It is also understood that the mounting system can secure the remote camera housing to a pedestrian.

In yet another aspect, the digital image capture camera can be mounted in a rear facing orientation.

In yet another aspect, a second digital image capture camera can be mounted in a forward facing orientation.

In yet another aspect, one or both of the cameras integrated into the Smartphone can be used to acquire images of the environment around the vehicle encroachment warning system.

In operation, the vehicle encroachment warning system:
a. Employs the digital image capture camera to acquire images of the environment around the vehicle encroachment warning system.
b. Software, preferably computer vision software, identifies the approaching object, determines the objects location and velocity (direction and speed) and compares that to the current location and velocity to determine the risk of a collision between the approaching vehicle and the object supporting the monitoring system.
c. When the software determines the risk of a collision between the approaching vehicle and the object supporting the monitoring system is of a sufficient level, the system activate at least one alerting mechanism. The alerting mechanism can be at least one of a visual alert, an audible alert, a tactile alert, and any other suitable alerting mechanism.
d. The system continues to monitor the presence, location, and velocity of the approaching vehicle respective to the object supporting the monitoring system. The system continues to monitor the risk of a collision between the approaching vehicle and the object supporting the monitoring system is reduced to a comfortable level or eliminated.
e. When the system determines that the risk of a collision between the approaching vehicle and the object supporting the monitoring system is reduced to a comfortable level or eliminated, the system ceases operation of the at least one alerting mechanism.

In an enhanced operation, the vehicle encroachment warning system further comprises a video recording system that maintains a history of the images acquired by the at least one image capture device(s).

In an enhanced operation, the vehicle encroachment warning system further comprises a forward oriented image capture device (camera). The forward oriented image capture device obtains images of vehicles in front of the system.

In another aspect of the operation, the vehicle encroachment warning system further comprises a display. The display presents at least one of the following to the user:
a. An image of the approaching vehicle.
b. A graphical image representing a location and direction of the approaching vehicle respective to the object supporting the monitoring system.
c. A graphical image representing a location and direction of all vehicles respective to the object supporting the monitoring system, including other bicycles, nearby motor vehicles, and the like.
d. A textural or human readable image providing a date and time.
e. A textural or human readable image providing quantitative values defining a location, speed, and direction of the object supporting the monitoring system.
f. A textural or human readable image providing quantitative values defining a location, speed, and direction of the approaching vehicle relative to the object supporting the monitoring system.
g. Location of the object supporting the monitoring system in any suitable format, including Global Positioning System (GPS) coordinates, longitude and latitude, a street address location, and the like.
h. A textural or human readable image and/or graphical representation providing weather conditions.
i. A textural or human readable image and/or graphical representation providing lighting conditions.

In yet another aspect of the operation, the vehicle encroachment warning system further comprises a communication system enabling communication between the vehicle encroachment warning system and adjacent vehicles, cyclists, pedestrians, and the like. The paired communication device can be a different Smartphone, a transceiver operating in accordance with the designated protocol or protocols, and the like.

In yet another aspect of the operation, the communication between the vehicle encroachment warning system and adjacent vehicles, cyclists, pedestrians is accomplished using at least one of a cellular communication circuit, a Bluetooth communication circuit, a Wi-Fi communication circuit, a Near Field Communication (NFC) circuit, and the like.

In yet another aspect of the operation, the communication between the vehicle encroachment warning system and adjacent vehicles, cyclists, pedestrians is accomplished using a unidirectional communication, wherein the vehicle encroachment warning system transmits a signal comprising a warning.

In yet another aspect of the operation, the communication between the vehicle encroachment warning system and adjacent vehicles, cyclists, pedestrians is accomplished using a unidirectional communication, wherein the vehicle encroachment warning system transmits a signal comprising a warning in a naming packet of a Bluetooth signal, a Wi-Fi signal, or any other similarly structured signal protocol.

In a second embodiment, the monitoring and alerting system includes:

A) At least one microprocessor, wherein said microprocessor is operated in accordance with a series of operational instruction sets, said operational instructional sets include:
a first, broad, detection analysis instruction set,
a second, precise, detection analysis instruction set, and
a user warning instruction set;

B) A first, broad, monitoring and analysis system; and

C) A second, precise, monitoring and analysis system.

In yet another aspect, the

[symbol]

The monitoring and alerting system initially utilizes the first, broad, monitoring and analysis system to identify and roughly determine a distance and velocity of an approaching vehicle. When the first, broad, monitoring and analysis system determines that the approaching vehicle is reaching a predetermined distance from the system, the system initiates the secondary and more precise monitoring and analysis system.

The first, broad, monitoring and analysis system can employ any suitable position determination system. The preferred embodiment would be a video capture and analysis system. The video capture and analysis system can utilize any suitable video capture system in conjunction with any suitable analysis algorithm. A preferred embodiment of the video capture and analysis system would be a computer vision system.

Computer vision is a field that includes methods for acquiring, processing, analyzing, and understanding images and, in general, high-dimensional data from the real world in order to produce numerical or symbolic information, e.g., in the forms of decisions. A theme in the development of this field has been to duplicate the abilities of human vision by electronically perceiving and understanding an image. This image understanding can be seen as the disentangling of symbolic information from image data using models constructed with the aid of geometry, physics, statistics, and learning theory. Computer vision has also been described as the enterprise of automating and integrating a wide range of processes and representations for vision perception.

Applications range from tasks such as industrial machine vision systems which, say, inspect bottles speeding by on a production line, to research into artificial intelligence and computers or robots that can comprehend the world around them. The computer vision and machine vision fields have significant overlap. Computer vision covers the core technology of automated image analysis which is used in many fields. Machine vision usually refers to a process of combining automated image analysis with other methods and technologies to provide automated inspection and robot guidance in industrial applications.

As a scientific discipline, computer vision is normally directed towards the theory behind artificial systems that extract information from images. The image data can take many forms, such as video sequences, views from multiple cameras, or multi-dimensional data from a medical scanner.

The second, precise, monitoring and analysis system can employ any suitable distance and velocity determination system, wherein the second, precise, monitoring and analysis system determines the distance and velocity of the approaching vehicle in a more accurate manner than the first, broad, monitoring and analysis system.

The preferred embodiment of the second, precise, monitoring and analysis system would be an infrared emitting and receiving system. The infrared solution provides a low power, high accuracy solution for determining the distance and velocity of the approaching vehicle. Alternative solutions for the second, precise, monitoring and analysis system include: RADAR, acoustics (SONAR, etc.), a laser emitter and receiver, an Infra-Red emitter and receiver, and the like.

The system would be assembled within any suitable housing/enclosure. One suggested enclosure is a cylindrical shape, preferably being aerodynamically designed to minimize wind resistance for bicycle riders. The device would include a mounting feature for removable attaching the device to another object, such as a bicycle, a motorcycle, powered scooters, an individual's arm (for walkers, runners, roller or blade skaters, skateboarders, scooters, and the like). The preferred embodiment would be a mounting system designed for attachment to a bicycle component, such as a bicycle frame.

The system would preferably include a digital video camera, a microprocessor, a digital memory device, a portable power supply such as a rechargeable battery, operational circuitry and respective software or operating instruction sets, at least one alerting system, an enclosure, and an attachment system. The system can additionally include a recharging connector, a programming connector, a monitor, a wireless communication system, an expansion system enabling integration of optional features or other enhancements with the system.

The preferred monitoring and alerting system initially utilizes a video capture and analysis system to identify an approaching vehicle. The video capture and analysis system is used to roughly determine the angle and velocity (speed and direction) of the approaching vehicle. Upon reaching a predetermined distance from the system, the system initiates the secondary and more precise monitoring system.

The system can be preprogrammed to determine a condition where the distance and velocity of the approaching vehicle appears to be on a collision course with the vehicle or other object employing the monitoring and alerting system. The system alerts the user when the system determines that a collision is impending. The system can provide a cautionary alert when the first, broad, monitoring and analysis system identifies an approaching vehicle. The system can provide a warning alert when the second, broad, monitoring and analysis system determines that the approaching vehicle suggests a condition of the potential impending collision.

The alert system can employ any suitable method/apparatus for alerting a user of the potential impending collision. The alerting system can be directed towards any suitable sense of the user, including visual alerts, audible alerts, tactile alerts, odorous alerts, and any combination thereof.

The system can include a visual and/or audible alerting system to alert the user of an impending collision. Upon notification, the user can take appropriate evasive actions. The alerting system can employ a series of illuminating devices, such as colored or multi-colored Light Emitting Diodes (LEDs). The LED's would illuminate in different colors, where the colors indicated the likelihood of the impending collision. i.e. green when the system is active and does not recognize any vehicles, yellow when the system identifies an upcoming vehicle (such as an advisory alert), amber when the system identifies a condition where the vehicle appears to be directed towards the device (such as a cautionary alert), and red when the system determines that the vehicle is within a certain range and/or approaching at a predetermined minimum speed (such as an alarming alert). Alternatively, the algorithm can utilize distance, direction, and velocity (or acceleration) to determine a concerning (alerting) condition and inform the user accordingly. The visual warning system can present a solid light emission, a series of solid light emissions, a strobing or flashing light, a series of strobing or flashing lights, and the like.

Alternatively (or in combination), the system can employ an audible alert system. The system can alert the user with a simple audible alert that can pulse (beep) at different rates, provide an escalating sound level (dB), present an audible message describing the situation, and the like in an escalating manner analogous with those described for the visual alerting system.

One exemplary audio alerting system would rely on distinct audio tones emitting directly from the device that communicate specific parameters as determined by the computer vision processor. For example:
A) A first alert audio beep would be emitted when an approaching or overtaking vehicle comes into range of the video monitoring system.
b) That alert audio beep would repeat in a form of a double beep when the distance and velocity of the approaching vehicle suggest an impending collision with the vehicle employing the system might occur within 5 seconds.
c) The alert audio beeps will continue as single spaced emissions as long as the approaching vehicle remains in the same lane and posing a threat to the cyclist. The alert audio beeps will increase in frequency in a condition where the approaching vehicle continues to get closer to the vehicle employing the system. The alert audio beep changes from a series of spaced beeps to a single continuous loud tone when distance and velocity of the approaching vehicle suggest an impending collision with the vehicle employing the system might occur within 3 seconds.
d) When the system determines that the distance and velocity of the approaching vehicle no longer suggests an impending collision, the system would emit an all clear audio signal in a form of a tone that is distinct from the caution or warning audible alerts.

The audible alerts can be emitted from a noise generating device integrated into the primary system enclosure or be provided through a noise generating device that is remotely mounted. The remotely mounted noise generating device can be attached to or integrated within a helmet, attached to an eyeglass or sunglass frame, integrated into a headband, be designed to be ear-mounted, and the like.

It is understood that the alerting output formats presented for the audible alert can be modified and adapted to other alerting methods.

In addition to warning the rider, the system can include light emitting warning devices and/or audible warning devices for alerting the driver of the approaching vehicle. Examples can include a rearward emitting series of bright light emitting diodes (LEDs) (preferably red or amber in color) programmed to either simply illuminate, flash or, illuminate in an sequence analogous to the alerting systems previously described; an audible alert such as a horn wherein the alerts would be similar in presentation as the escalating series of bright light emitting diodes (LEDs); and the like.

The system can employ one or more digital video cameras. When employing two or more cameras, the system can utilize stereo video for calculating the velocity and distance of the approaching vehicle.

The system can utilize a zoom feature integrated into the camera (either lens and/or digital zoom) to aid in determining the velocity and direction of the approaching vehicle.

In use, the device would be mounted to an object/person at a suitable height for monitoring and identifying approaching vehicles. The device would locate and orient the camera and other monitoring systems to provide an unencumbered rear view which would cover the rear lane and an adjacent lane.

The system would be capable of detecting a vehicle; car, truck, motorcycle, RV or any other vehicle approaching from the rear of the system. The system can utilize the speed and direction of the system and the determined speed and direction of the approaching vehicle to determine if a collision is likely. The system can utilize vector calculations to mathematically model the speed and direction of each of the vehicle and the system to determine the likelihood of an impending collision.

The system can include recognition software to identify/distinguish between lanes. The system can optionally utilize a striping of a roadway to identify each lane.

The system can determine if a vehicle is traveling in a direction opposite to the direction of travel of the system. The system can ignore these vehicles.

The system would initially consider that the system is traveling in the rightmost lane. The system can include an optional feature to inform the user when the user strays from the rightmost (or correct) lane of travel. Additionally, the system can monitor that the travel is within one meter of the right edge of the correct lane of travel. The system would monitor for any vehicle overtaking the user/system within a 2 meter distance.

The system can provide an initial warning when the system determines that an approaching vehicle will be overtaking the system location within either a predetermined time and/or predetermined distance. An exemplary time would be 4 second and an exemplary distance would be 100 meters. The system can monitor for both time and distance and issue an alert upon a first met condition.

Upon activating, the system will begin recording the captured video with a time and date stamp on the video. Simultaneously the system will trigger at least two additional switches, one to turn on two sets of flashing LEDs and a second to operate a noise generating circuit, i.e. a piezoelectric horn to alert the Platform operator. All three switches should stay closed until detected vehicles are past the Platform. The horn may be a single tone alert that resets automatically after each activation.

Additional features could include:

A Global Positioning System (GPS) to determine and optionally record locations, velocity, and other information.

A memory system capable of recording video (and optionally audio). The system can optionally active the video recording system when it is determines a vehicle is approaching. The system can further limit the initiation of the video recording system to a condition where the system determines that a collision is impending. The video recording system can simultaneously record time, day and/or date, video, audio, location data of the system, velocity data of the system, determined distance and velocity data of the approaching vehicle, weather conditions, lighting conditions, and the like.

The system can additionally include accelerometers to determine force of any impact. The force can be recorded in the memory system.

Base upon a predetermined criteria, the system will begin recording the captured video with a time and date stamp on the video. The system can additionally record GPS information, including location, speed, direction of travel, and the like of the system and respective calculated information of the approaching vehicle. In one example, the system would activate the video recorder when the system determines that a distance and velocity of the approaching vehicle suggest an impending collision with the vehicle employing the system might occur within 3 seconds. Simultaneously the system will trigger at least two additional switches, one to turn on two sets of flashing LEDs and a second to operate a noise generating circuit, i.e. a piezoelectric horn to alert the platform operator. All three switches should stay closed until detected vehicles are past the platform. The audible alert may be a single tone alert that resets automatically after each activation.

The system would reset once the subject approaching vehicle(s) has passed the system.

### BRIEF DESCRIPTION OF THE DRAWINGS

The preferred embodiments of the invention will hereinafter be described in conjunction with the appended drawings provided to illustrate and not to limit the invention, in which:

FIG. 1 presents a side elevation view of an exemplary vehicle encroachment warning system installed onto a bicycle;

FIG. 2 presents an exemplary schematic diagram of the vehicle encroachment warning system;

FIG. 3 presents an exemplary plan view of a cyclist riding environment, the view illustrating an exemplary operation of the vehicle encroachment warning system;

FIG. 4 presents an exemplary monitoring system flow diagram, including an optional two stage monitoring feature;

FIG. 5 presents a detailed exemplary two stage approaching vehicle monitoring flow diagram;

FIG. 6 presents an enlarged exemplary plan view of FIG. 3, illustrating an exemplary operation of the vehicle encroachment warning system;

FIG. 7 presents a plan view detailing an exemplary display of the vehicle encroachment warning system during use;

FIG. 8 presents an enlarged plan view of the environment vehicle location and motion reference image;

FIG. 9 presents an enlarged plan view of the exemplary bicycle comprising an enhanced version of the vehicle encroachment warning system;

FIG. 10 presents an isometric rear view of an exemplary eyewear comprising visual alerts and audible alerts integrated therein;

FIG. 11 presents an elevation view of the vehicle encroachment warning system being used by a pedestrian;

FIG. 12 presents an enlarged elevation view of the exemplary bicycle comprising an a version of the vehicle encroachment warning system, wherein the warning system is operated by a Smartphone;

FIG. 13 presents an enlarged elevation view of a seat section the exemplary bicycle detailing a rear facing digital image capture system or camera;

FIG. 14 presents an enlarged partially sectioned plan view of the Smartphone introducing the various operating component thereof;

FIG. 15 presents a schematic diagram introducing various optional configurations and associated communication links between various components to create alternative functioning vehicle encroachment warning systems;

FIG. 16 presents an enlarged elevation view of the exemplary bicycle introducing alternative mounting configurations for integrating the Smartphone into the vehicle encroachment warning system;

FIG. 17 presents a side view of an exemplary Smartphone mounting system, the mounting system introducing an image redirecting or diverting subassembly; and

FIG. 18 presents an enlarged exemplary plan view of the cyclist riding environment, the view illustrating an exemplary communication link between the vehicle encroachment warning system and an adjacent vehicle.

Like reference numerals refer to like parts throughout the several views of the drawings.

### DETAILED DESCRIPTION

Detailed embodiments of the present invention are disclosed herein. It will be understood that the disclosed embodiments are merely exemplary of the invention that may be embodied in various and alternative forms. The figures are not necessarily to scale, and some features may be exaggerated or minimized to show details of particular embodiments, features, or elements. Specific structural and functional details, dimensions, or shapes disclosed herein are not limiting but serve as a basis for the claims and for teaching a person of ordinary skill in the art the described and claimed features of embodiments of the present invention. The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

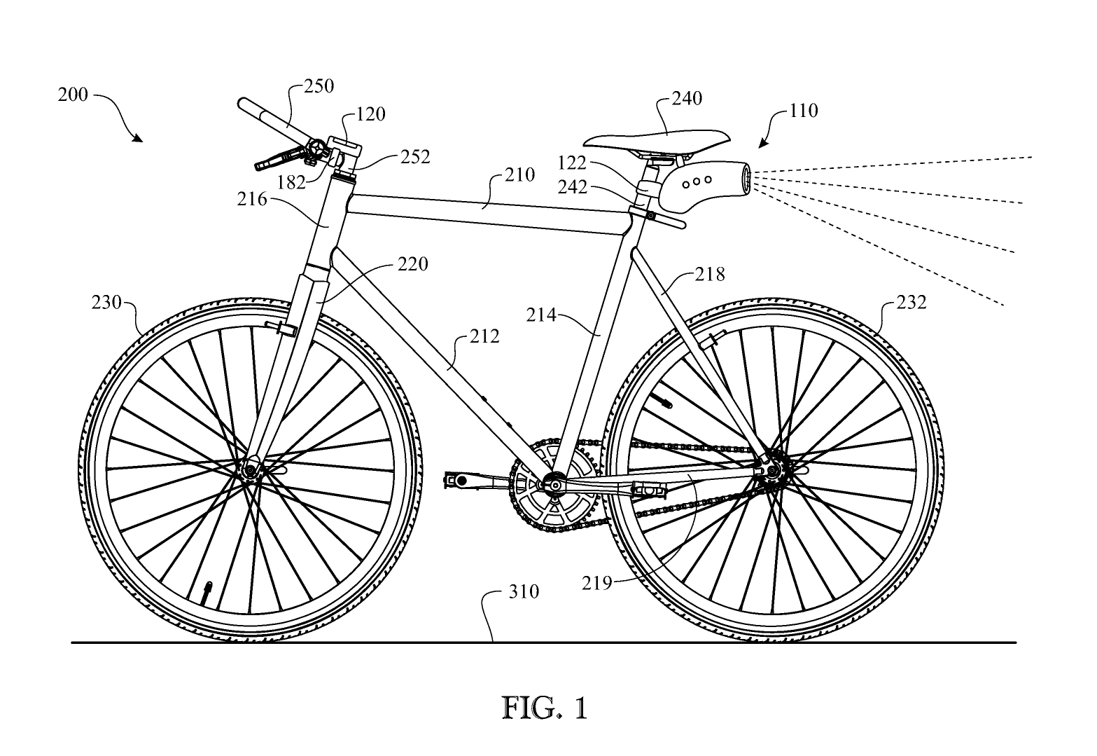

For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Every year, in the United States, around 19,000 cyclists are killed or injured in reported road accidents, including approximately 3,000 who are killed or seriously injured. Cyclist casualties have risen in recent years as the amount of cycling has increased.

Most cycling accidents happen in urban areas where most cycling takes place. Almost two-thirds of cyclists killed or seriously injured were involved in collisions at, or near, a road junction, with T junctions being the most commonly involved. Roundabouts are particularly dangerous junctions for cyclists. Not surprisingly, the severity of injuries suffered by cyclists increases with the speed limit, meaning that riders are more likely to suffer serious or fatal injuries on higher speed roads. Almost half of cyclist deaths occur on rural roads.

Bicyclists commonly ride in a bike lane, located on a far right side of a roadway. Laws require motor vehicles to maintain a three (3) foot distance from any cyclist. These laws were established to help reduce accidents and save lives. Unfortunately, accidents continue to occur. As the number of bicyclists continues to rise, particularly in urban environments, the number of accidents and resulting injuries and deaths also continue to rise.

In collisions involving a bicycle and another vehicle, the most common key contributory factor recorded by the police is ‘failed to look properly’ by either the driver or rider, especially at junctions. ‘Failed to look properly’ was attributed to the car driver in 57% of serious collisions and to the cyclist in 43% of serious collisions at junctions.

These collisions can be reduced by simply warning at least one of the bicyclist and the driver of a potential collision. If the cyclist is warned of an approaching vehicle, the cyclist can react accordingly to avoid a collision. If the driver is informed that they are approaching a cyclist, the driver can be more aware of the cyclist and avoid a collision.

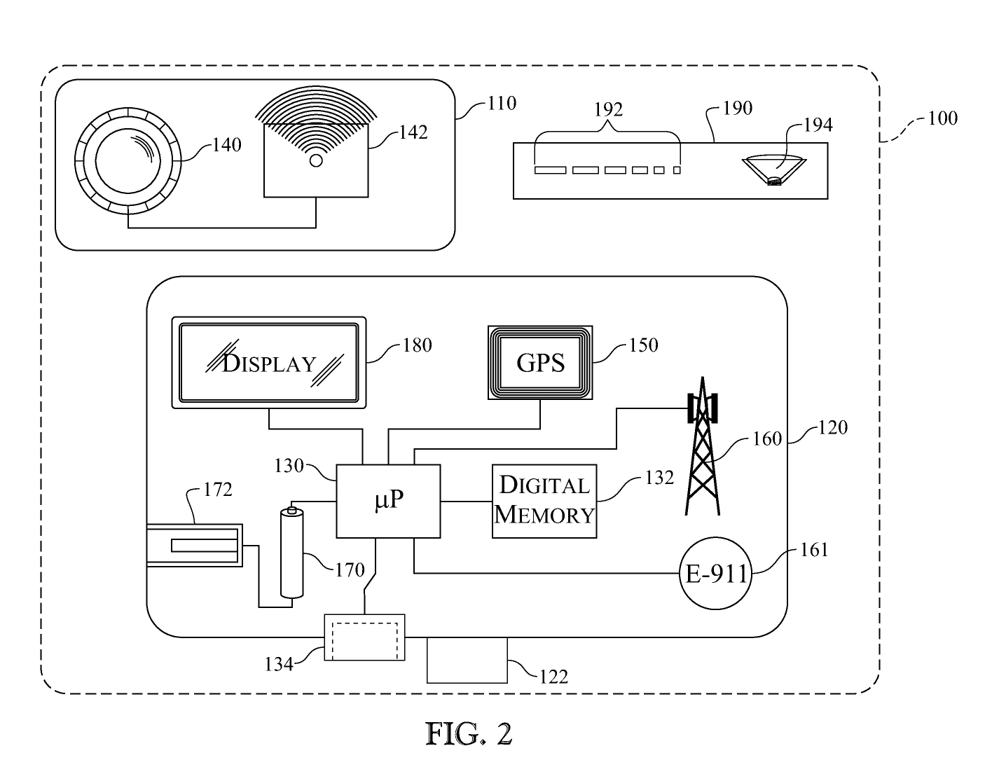

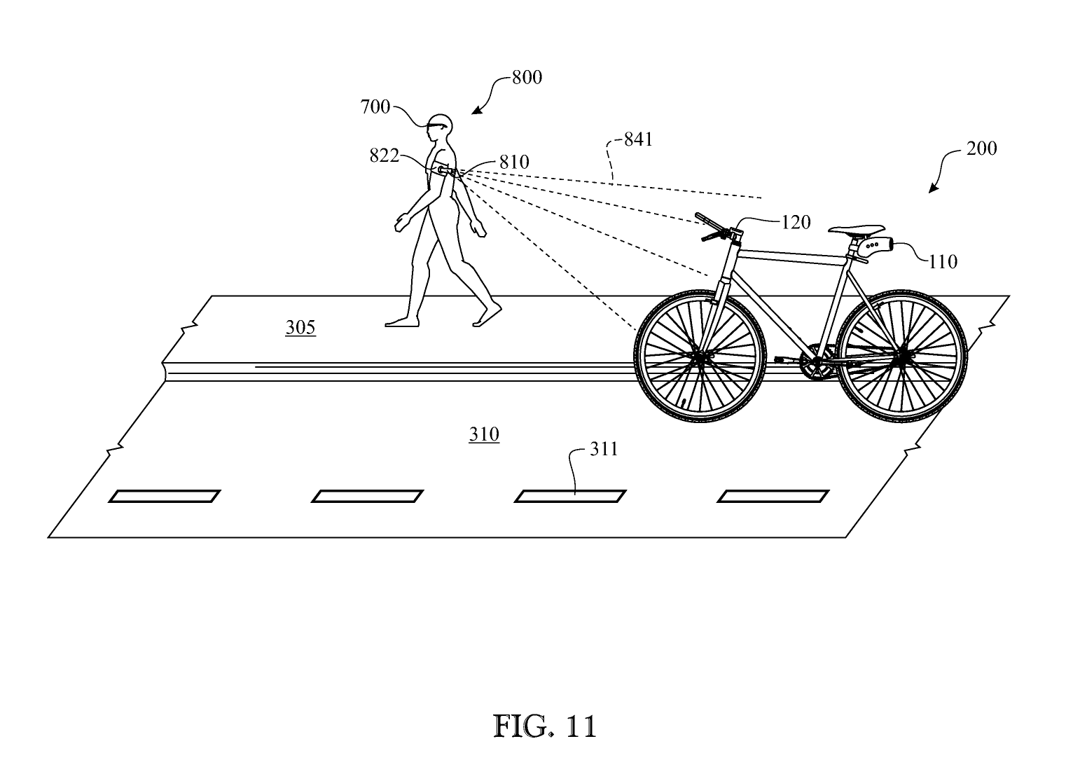

The present invention discloses a vehicle encroachment warning system 100, detailed in FIG. 2, which is intended to reduce collisions between bicyclists and vehicles. Although the primary application is directed towards employment of the vehicle encroachment warning system 100 upon a bicycle 200, as illustrated in FIGS. 1, 3, 6, 9, it is understood that the same system can be adapted for use in other applications, such as pedestrians, as illustrated in FIG. 11, human powered three-wheeled vehicles or tricycles, human powered multi-wheeled vehicles, motorized two-wheeled vehicles, motorized three-wheeled vehicles or trikes, motorized four-wheeled vehicles, motorized multi-wheeled vehicles, watercraft, aircraft, and the like.

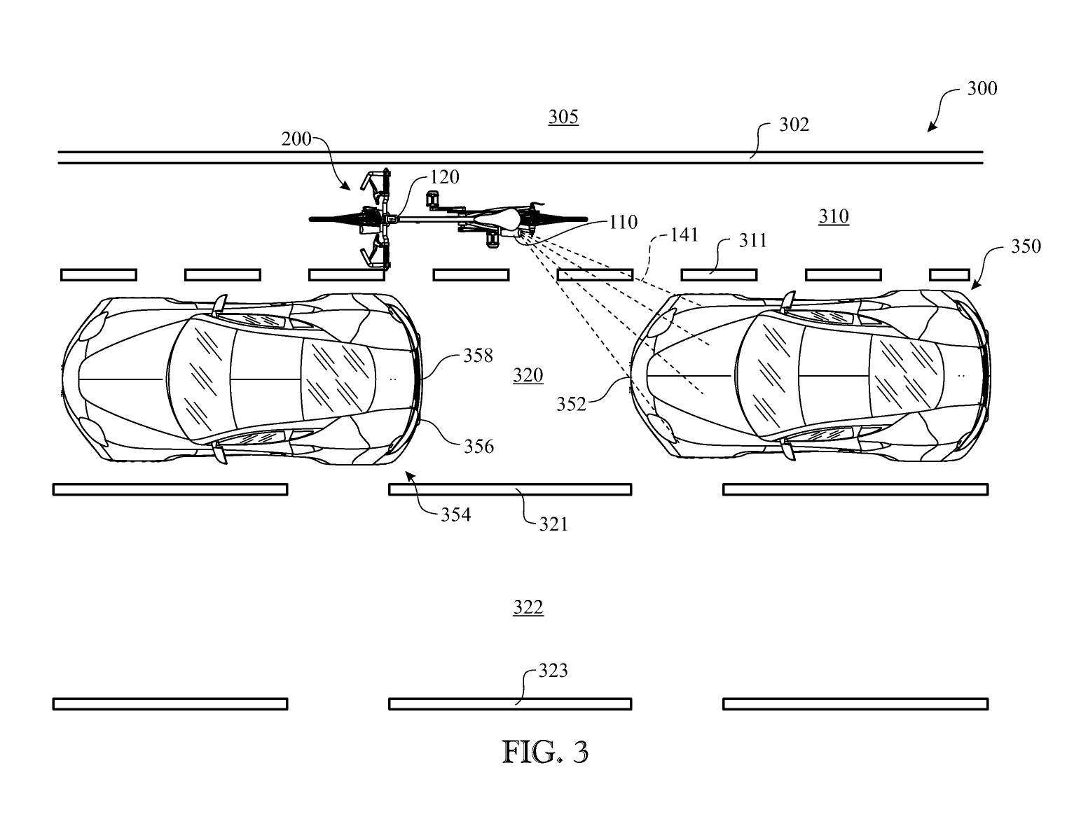

Details of a cycling environment are described in FIG. 3. Cycling accidents commonly occurs when a bicyclist 200 collides with a vehicle approaching from the rear 350. Cyclists or riders travel along an outer lane of traffic, following the direction of flow of traffic. The outer lane would be the lane nearest the shoulder of the roadway. When available, the cyclist rides in a dedicated bicycle travel lane 310, which is presented in the exemplary illustrations shown herewith. The collision results from the bicyclist encroaching or crossing into an adjacent vehicle travel lane 320 and/or the rear approaching vehicle 350 encroaching or crossing into the dedicated bicycle travel lane 310. Making the rider or cyclist aware of the rear approaching vehicle 350, reduces the risk of an accident. Vehicles may be traveling at a high rate of speed. Therefore, the earlier the rider or cyclist becomes aware of the approaching vehicle 350, the more cognizant the rider or cyclist can be of the situation. Vehicles approaching at a high rate of speed can reach a bicycle 200 in a very short period of time. Therefore, it is imperative that the rider or cyclist be aware of the approaching vehicle 350 in a timely manner, or when the approaching vehicle 350 is still at a suitable distance away (thousands of feet). The vehicle encroachment warning system 100 can include an escalating warning process; initially emitting an alert to inform the rider or cyclist of the approaching vehicle 350, increasing the alert to a warning to ensure the rider or cyclist monitors the distance and direction of the approaching vehicle 350 as the vehicle comes closer to the bicycle 200, and finally increasing the alert to a danger notification to ensure the rider or cyclist takes any necessary evasive action to avoid a collision with the approaching vehicle 350.

In the exemplary implementations, the vehicle encroachment warning system 100 is installed onto the bicycle 200. The bicycle 200 includes a frame comprising a number of segments joined together, including a bicycle frame top tube section 210, a bicycle frame down tube section 212, a bicycle frame seat tube section 214, a bicycle frame head tube section 216, a pair of bicycle frame seat stay sections 218, and a pair of bicycle frame chain stay sections 219. It is understood that the bicycle 200 may include additional tubular members or exclude one or more of the described tubular members. For example, the frame of the bicycle 200 may include a bicycle frame down tube section 212 designed and fabricated to eliminate the bicycle frame top tube section 210. Similarly, the structure of the bicycle 200 may combine the bicycle frame seat stay section 218 and bicycle frame chain stay section 219 into a single member. A bicycle frame fork assembly 220 is rotationally assembled to the frame of the bicycle 200 through the bicycle frame head tube section 216. A handlebar 250 is fixed to the bicycle frame fork assembly 220 by a handlebar stem 252. The rotational motion of the bicycle frame fork assembly 220 enables the bicyclist to steer the bicycle 200 while riding by way of rotating the handlebar 250. A seat or saddle 240 is supported by a seat post 242, which is assembled to the bicycle frame seat tube section 214. The seat post 242 is commonly slideably inserted into the bicycle frame seat tube section 214, positioned vertically for the rider or bicyclist and locked into place by a clamping element. Travel is provided by way of rotationally assembling a front tire and wheel assembly 230 to the bicycle frame fork assembly 220 and rotationally assembling a rear tire and wheel assembly 232 to the section of the frame comprising the pair of bicycle frame seat stay sections 218 and the pair of bicycle frame chain stay sections 219. The structure of the frame of the bicycle 200 provides a latitude of locations for installing the components of the vehicle encroachment warning system 100. The tubular structure of the frame of the bicycle 200 enables concealment of wires or cabling for the vehicle encroachment warning system 100. Additional components, which are illustrated, but not identified, include a sprocket, peddles, a chain, brakes, and other commonly integrated components providing operation of the bicycle 200.

In a first exemplary variant of the present invention, a vehicle encroachment environment sensing system 110 is installed onto the bicycle 200 by securing a vehicle encroachment warning system housing mounting bracket 122 to the seat post 242. It is understood that the vehicle encroachment environment sensing system 110 can be installed onto a supporting frame of the seat or saddle 240, one or both of the pair of bicycle frame seat stay sections 218, or any other suitable component of the bicycle 200. A vehicle encroachment warning system control unit 120 would be installed onto the bicycle 200 at a location that is visible and accessible by the rider or bicyclist. For example, the vehicle encroachment warning system control unit 120 could be affixed to the handlebar 250 or the handlebar stem 252 using a mounting configuration. The mounting configuration can have a fixed design or an adaptable design, enabling the rider or bicyclist to optimize the position, angle, height, etc. for the rider. Although details are not provided, it is understood that those skilled in the art can design a mounting configuration adapted to accommodate the flexibility of the design to optimize the position, angle, height, etc. for the rider.

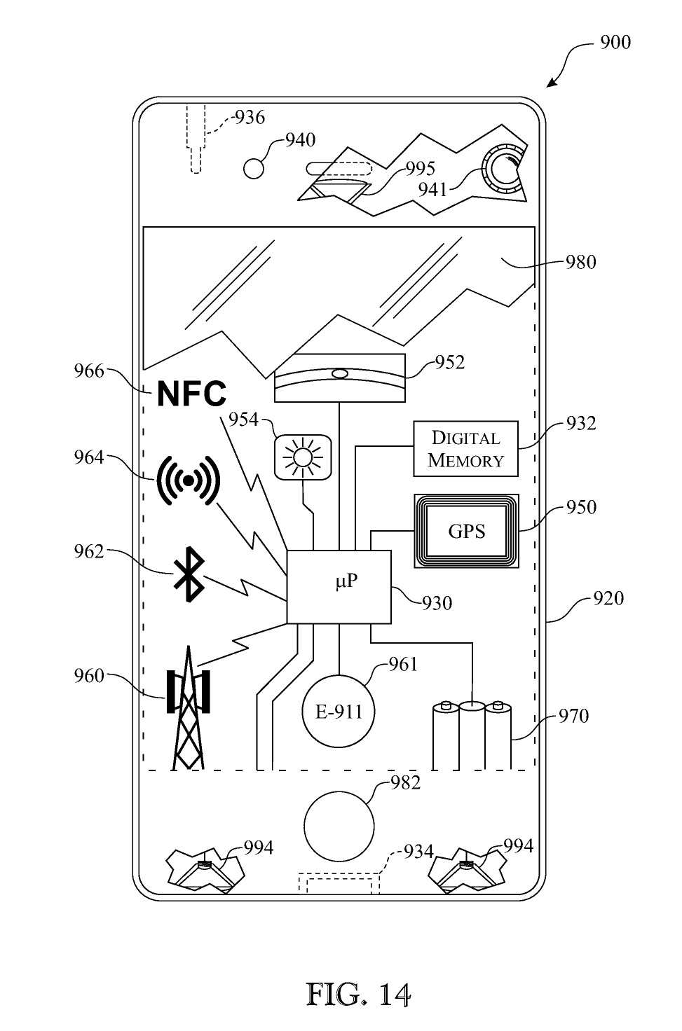

The vehicle encroachment warning system 100 can employ a custom designed control unit, as shown in FIG. 2 or adapt the functionality to an encroaching vehicle application enabled Smartphone 900, as shown in FIG. 14. A number of the components of the vehicle encroachment warning system 100 and encroaching vehicle application enabled Smartphone 900 are similar, wherein like components of the vehicle encroachment warning system 100 and encroaching vehicle application enabled Smartphone 900 are numbered the same except proceeded by the number “1” or “9” respectively. Additional, distinguishing elements are numbered uniquely accordingly.

Operational control components are preferably packaged within the vehicle encroachment warning system control unit 120. Environmental sensing components are preferably packaged within the vehicle encroachment environment sensing system 110.

A microprocessor 130 directs operation of the vehicle encroachment warning system 100 in accordance with a set of instructions. The set of instructions are commonly referred to as at least one of software, firmware, and the like. The set of instructions can be stored in either the microprocessor 130 or a digital memory 132. The digital memory 132 is provided to retain a history of use, including audio and visual elements of video, still images, time, telemetry data of the system (speed, direction, location, and the like), telemetry data of one or more adjacent vehicles (speed, direction, location respective to the system, and the like), weather conditions, lighting conditions, and any other pertinent information. The digital memory 132 can be of any suitable format, including volatile and/or non-volatile memory. The digital memory 132 can include hard disk drives, solid state drives, and the like.

The vehicle encroachment warning system 100 includes several information acquisition elements. A first information acquisition element is a visual environment sensing circuit (camera) 140. The visual environment sensing circuit (camera) 140 would be mounted to the supporting body (bicycle 200) facing generally rearward. The visual environment sensing circuit (camera) 140 would be in signal communication with the microprocessor 130 using either a wired or wireless communication link. The visual environment sensing circuit (camera) 140 could optionally be angled slightly towards a street (left side of the camera in a right side drive country/right side of the camera in a left side drive country). If needed, the system would be calibrated once the visual environment sensing circuit (camera) 140 is mounted to the supporting body (bicycle 200).

In certain configurations, such as a two stage monitoring system, the vehicle encroachment warning system 100 could utilize a second information acquisition element. The second information acquisition element is a radar environment sensing circuit 142. The radar environment sensing circuit 142 would be in signal communication with the microprocessor 130 using either a wired or wireless communication link. The radar environment sensing circuit 142 would be mounted to the supporting body (bicycle 200) facing generally rearward. The radar environment sensing circuit 142 could optionally be angled slightly towards a street (left side of the camera in a right side drive country/right side of the camera in a left side drive country). If needed, the system would be calibrated once the radar environment sensing circuit 142 is mounted to the supporting body (bicycle 200). The visual environment sensing circuit (camera) 140 and radar environment sensing circuit 142 could be integrated into a single enclosure, providing a single mounting system and simplifying the calibration process.

A third information acquisition element is a Global Positioning System (GPS) circuit 150. The Global Positioning System (GPS) circuit 150 would be in signal communication with the microprocessor 130 using either a wired or wireless communication link. The Global Positioning System (GPS) circuit 150 could be integrated into the enclosure containing the visual environment sensing circuit (camera) 140 and radar environment sensing circuit 142 or a central control unit that would be installed at a location near or onto the handlebar 250. In a configuration where the Global Positioning System (GPS) circuit 150 is integrated into the control unit, the Global Positioning System (GPS) circuit 150 can be assembled to a controller Printed Circuit Board (PCB); being integrated as a subsystem of a controller Printed Circuit Assembly (PCA).

A communication circuit, such as a cellular communication circuit 160 can optionally be integrated into the vehicle encroachment warning system 100. The cellular communication circuit 160 could be integrated into the enclosure containing the visual environment sensing circuit (camera) 140 and radar environment sensing circuit 142 or a central control unit that would be installed at a location near or onto the handlebar 250. The instruction set can optionally include instructions for operation of the cellular communication circuit 160, wherein the instructions for operation of the cellular communication circuit 160 include steps for conserving power. The instruction set would place the cellular communication circuit 160 in a sleep mode until the vehicle encroachment warning system 100 needs to communicate. When the need arises, the instruction set would activate the transceiver of the cellular communication circuit 160 and proceed in communicating accordingly.

One optional inclusion associated with the cellular communication circuit 160 is an e-911 autodial circuit 161. The e-911 autodial circuit 161 enables the user to automatically dial emergency 911 (e-911) with a single contact. This has several benefits, including simplifying the process should the user be injured, such as a fall or accident; reducing the time required to call should the user be subjected to an emergency situation, concealing initiation of the call should the user be subjected to a potentially dangerous situation involving other persons, such as a robbery, an assault, and the like; among others.

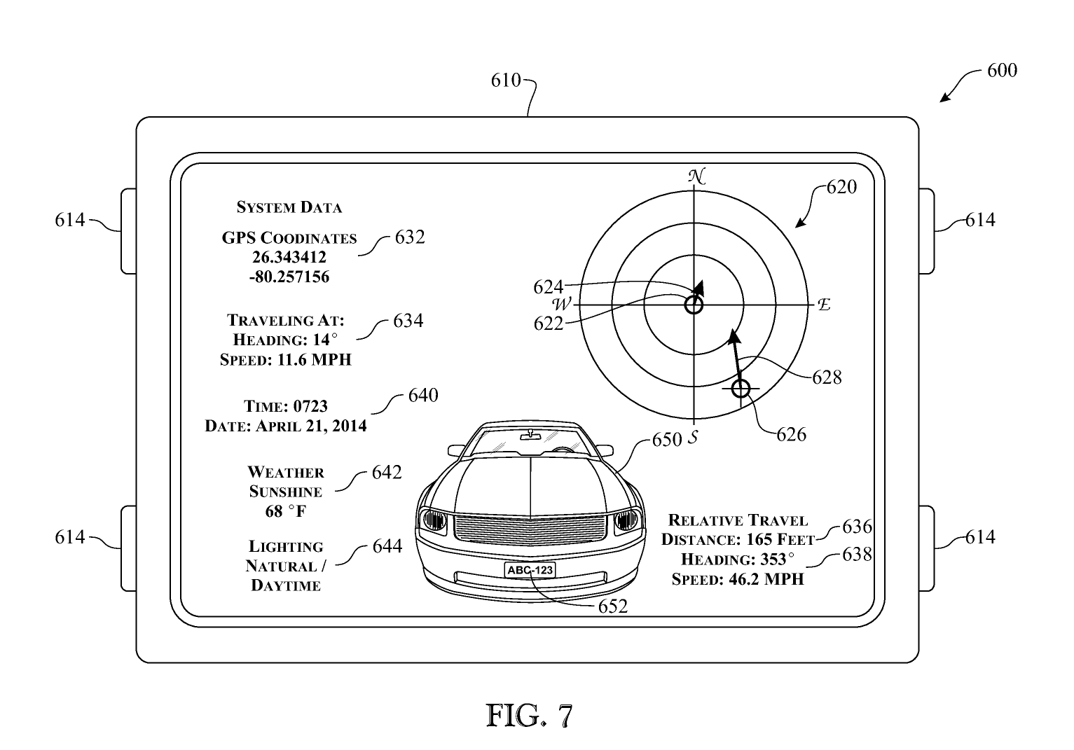

The vehicle encroachment warning system 100 can include at least one user interface device. The at least one user interface device can include a display 180, a visual alert 192, an audible alert 194, or any other suitable component. The display 180 provides the system with an ability to convey a wide variety of information, such as the exemplary display presented in FIG. 7, which will be detailed later within this specification. The visual alert 192 provides a simple visual alert to the user. The visual alert 192 can be a single colored illuminating element, such as a Light Emitting Diode (LED), an incandescent bulb, a florescent bulb, and the like. The visual alert 192 can include a multi-colored illuminating system, such as multiple single-colored illuminating elements, at least one multi-colored Light Emitting Diode (LED), and the like. The visual alert 192 can be mounted at any suitable location or apparatus, such as within an alert system 190 that could be mounted onto the handlebar 250, integrated within a monitoring system flow diagram 400, integrated into a helmet (now shown), integrated into a headband (not shown), integrated into a hat (not shown), and any other suitable apparatus.

The vehicle encroachment warning system 100 includes an interface connector 134, preferably integrated into the controller unit, wherein the interface connector 134 enables connectivity between the controller unit and external components, such as the visual environment sensing circuit (camera) 140 and the optional radar environment sensing circuit 142. The interface connector 134 also provides an ability to utilize wires for connecting the alert system 190. The interface connector 134 can be of any suitable form factor, including a Universal Serial Bus (USB) connector, a micro USB connector, a 30 pin dock connector, a lightning connector, or any other signal connector.

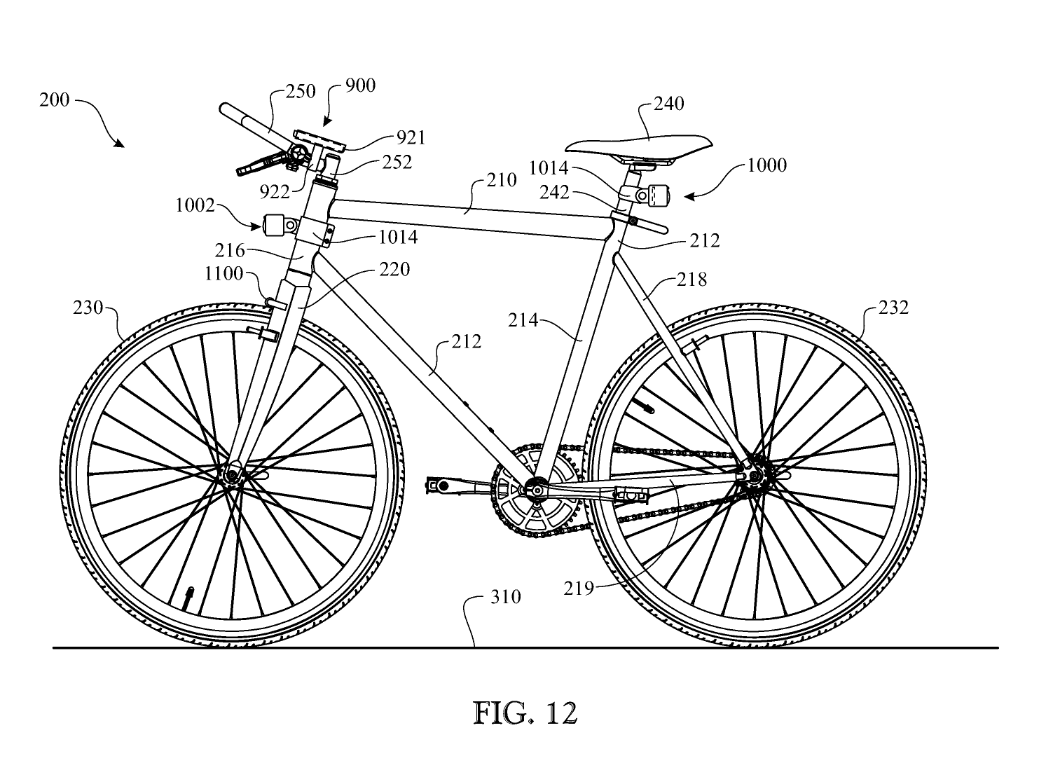

Power is provided by a portable power supply 170. The portable power supply 170 can be a battery (disposable or rechargeable), a super capacitor, a power generating device such as a solar power converter, and the like. Power can also be provided to the device by connecting a cable between a remote power source and a power/charging connector 172, wherein the remote power source could be a wall outlet for recharging the portable power supply 170, an electrical power generator 1100 (FIG. 12) that converts rotational motion of the respective wheel 230, 232 into electrical energy, converting vibrational motion into electrical energy using a piezoelectric or similar motion converting charging system which obtains energy from vibration or motion during travel, and the like. The system can include a power regulating circuit (not shown) to manage input power, distribution of power, voltage and/or amperage changes, and the like. It is noted that the interface connector 134 can include power connections, thus combining the functionality of the interface connector 134 and the power/charging connector 172 into a single connector.

As mentioned above, the vehicle encroachment warning system 100 can be installed in any of a variety of configurations. One exemplary installation configuration is presented in FIGS. 1, 3, and 6. In the exemplary installation, the visual environment sensing circuit (camera) 140 and radar environment sensing circuit 142 are integrated into the vehicle encroachment environment sensing system 110 and installed in a rear facing orientation onto the bicycle 200. In the exemplary installation configuration, the vehicle encroachment warning system control unit 120 is secured to the handlebar stem 252 by a display mount subsystem 182.

Also shown in the exemplary installation configuration, the vehicle encroachment environment sensing system 110 is secured to the bicycle frame seat tube section 214 by a vehicle encroachment warning system housing mounting bracket 122. It is noted that the exemplary illustrations the vehicle encroachment environment sensing system 110 is shown in an oversized scale that is significantly larger than the intended final product. This is specifically for clarity to aid in the disclosure of the subject invention. The intended product will be a form factor having a size of a lipstick container and would be mounted underneath the seat or saddle 240. This would minimize any impact to the weight of the bicycle 200 and any airflow resistance during use. The vehicle encroachment environment sensing system 110 can be self contained, including a portable power supply and employ wireless communication to convey information with the controller unit. Alternatively, the vehicle encroachment environment sensing system 110 can utilize signal and optional power cabling to obtain power and convey information with the controller unit. The signal and optional power cabling would preferably be routed through the hollow interior of the tubular members of the frame of the bicycle 200.

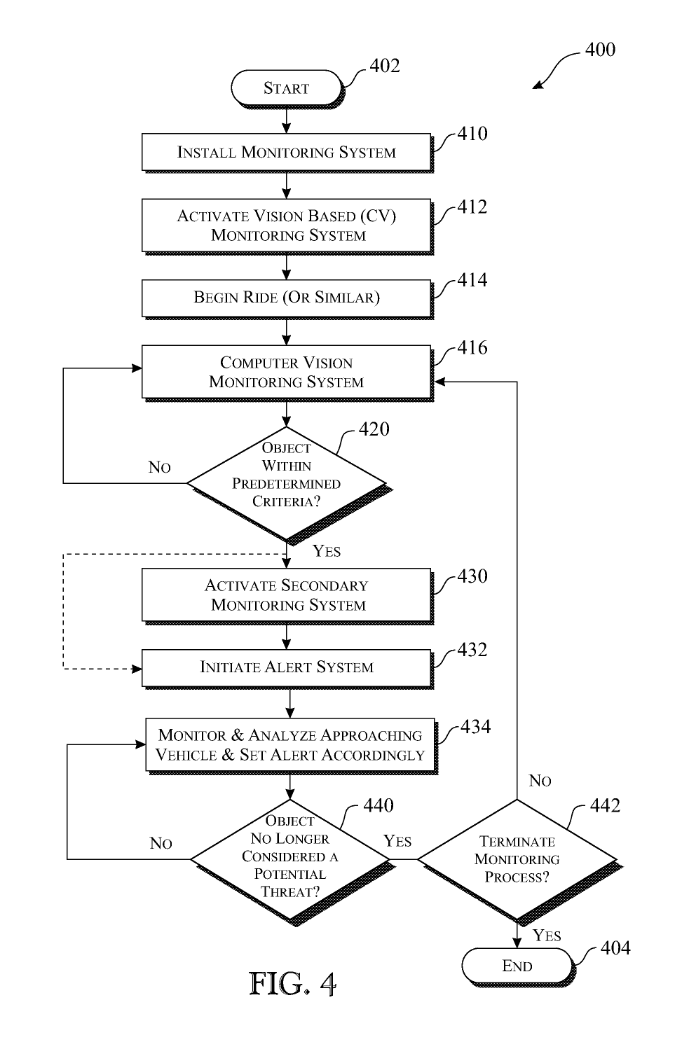

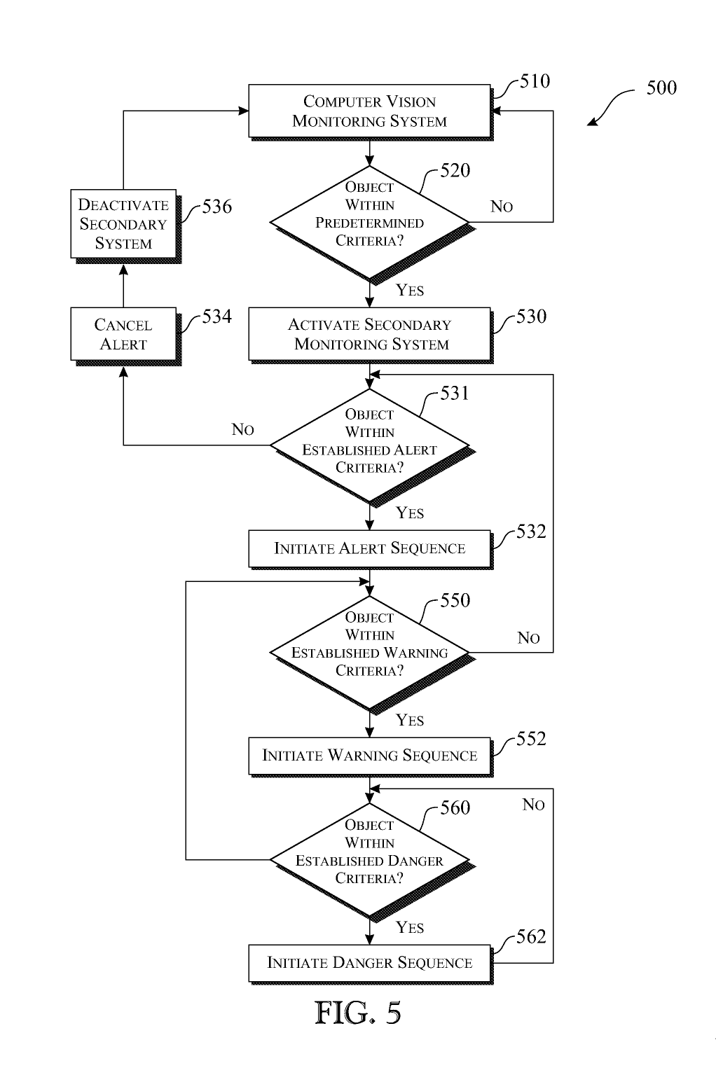

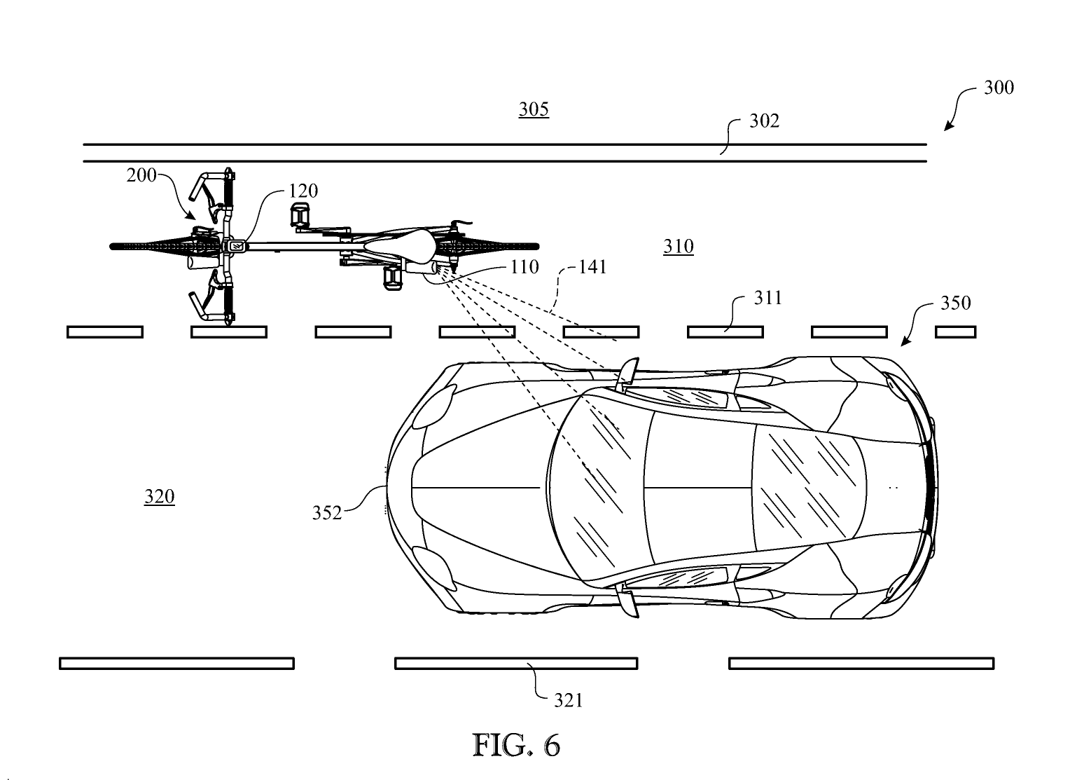

Functionality of the vehicle encroachment warning system 100 is demonstrated in FIGS. 3 and 6, and described in flow diagrams 400, 500 presented in FIGS. 4 and 5.

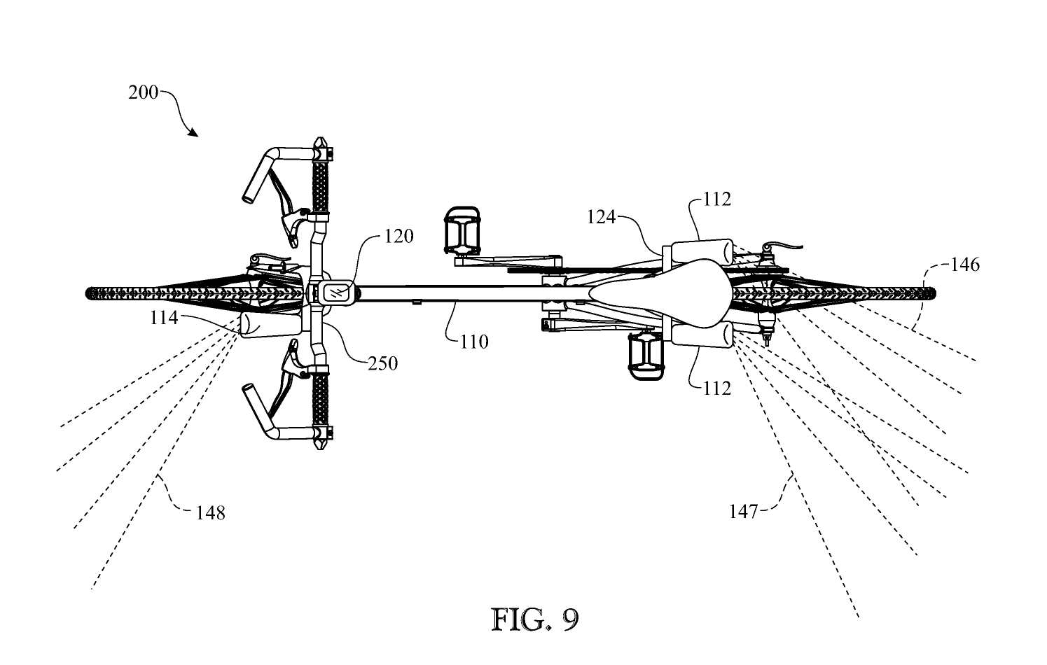

The monitoring system flow diagram 400 commences with an initiation step 402. The installer determines the desired configuration and collects the necessary components for the desired configuration. Several configurations will be described herein. The vehicle encroachment warning system 100 is installed (block 410) locating the vehicle encroachment warning system control unit 120 in a location that is visible and preferably accessible by the rider while cycling. In the exemplary illustration, the vehicle encroachment warning system control unit 120 is secured to the handlebar 250 by the display mount subsystem 182. The vehicle encroachment environment sensing system 110 could include the vehicular traffic sensing device or devices. In one configuration, the vehicular traffic sensing device includes the visual environment sensing circuit (camera) 140. In a second configuration, the vehicular traffic sensing device includes the visual environment sensing circuit (camera) 140 and an additional radar environment sensing circuit 142. In a third configuration, the vehicle encroachment environment sensing system 110 is replaced with a dual camera rear facing environment monitoring system 112, wherein the vehicular traffic sensing device of the dual camera rear facing environment monitoring system 112 includes a pair of visual environment sensing circuits (cameras) 140, as illustrated in FIG. 9. The exemplary dual camera rear facing environment monitoring system 112 is secured to the bicycle 200 by a dual camera vehicle encroachment warning system housing mounting bracket 124.

The pair of visual environment sensing circuit (camera) 140 introduces a stereo vision capability into the vehicle encroachment warning system 100. The vehicle encroachment environment sensing system 110, 112 is installed onto the bicycle 200 with the visual environment sensing circuit (camera) 140 arranged in a rearward facing orientation. In the exemplary illustration, the vehicle encroachment environment sensing system 110, 112 is secured to the seat post 242. As indicated above, the intended product will be packaged in a form factor having a size of a lipstick container and could be mounted underneath the seat or saddle 240. The vehicle encroachment environment sensing system 110, 112 could optionally be angled slightly towards a street (left side of the camera in a right side drive country/right side of the camera in a left side drive country). The vehicle encroachment warning system 100 can be enhanced with the inclusion of a forward facing environment monitoring system 114. The forward facing environment monitoring system 114 would include another visual environment sensing circuit (camera) 140. The forward facing environment monitoring system 114 would be secured to a forward component of the bicycle 200. The forward facing environment monitoring system 114 can be secured to the bicycle frame head tube section 216 in a manner similar to the camera mounting bracket arm 1012 shown in FIG. 12, secured to the handlebar stem 252, the bicycle frame fork assembly 220, the handlebar 250 or any other suitable component of the bicycle 200. Each location would have advantages and disadvantages. For example, when mounted to the bicycle frame head tube section 216, the forward facing environment monitoring system 114 remains stationary respective to the steering of the bicycle, Conversely, when mounted to the bicycle frame fork assembly 220, the handlebar stem 252, or the handlebar 250, the direction of the forward facing environment monitoring system 114 changes in accordance with a rotation of the steering system. A stationary mounting configuration ensures the direction of the forward facing environment monitoring system 114 remains stationary and captures an image in a direction of the bicycle 200. A rotational mounting configuration allows the rider/cyclist the ability to redirect the direction of the forward facing environment monitoring system 114 in accordance with their proposed direction of travel. More specifically, the images are captured in the direction in which the bicycle 200 is going to be traveling.

Each visual environment sensing circuit (camera) 140 and optional radar environment sensing circuit 142 would be in signal communication with the microprocessor 130 using either a wired or wireless communication link. When using the wired communication link, the wires or cabling could be routed within the hollowed interior of the tubular sections of the frame of the bicycle 200. The cabling could be provided with connectors to simplify the installation process.

Once installed, the rider/cyclist would initiate the monitoring process (step 412). The vehicle encroachment warning system 100 may require calibration. This can be completed upon initiation of the monitoring process. It is noted, the calibration may be a one-time process, wherein calibration data would be stored within the digital memory 132 of the vehicle encroachment warning system 100. Alternatively, the calibration may be required upon each activation sequence. In a blended scenario, the primary calibration may be completed after an initial installation, whereby the system would require completion of a brief calibration verification step prior to each use.

The rider/cyclist begins riding the bicycle 200 (step 414). Details of the environment where a rider/cyclist commonly cycles is presented by an exemplary roadway scenario 300 illustrated in FIGS. 3 and 6. The exemplary roadway scenario 300 includes a dedicated bicycle travel lane 310 defined between a roadway curb 302 and a dedicated bicycle travel lane marker 311. A sidewalk 305 is commonly provided on an opposite or pedestrian side of the roadway curb 302. An adjacent vehicle travel lane 320 is located adjacent to the dedicated bicycle travel lane 310, wherein the adjacent vehicle travel lane 320 is defined by the dedicated bicycle travel lane marker 311 and an adjacent vehicle travel lane marker 321. An outer vehicle travel lane 322 is located adjacent to the adjacent vehicle travel lane 320 and distant from the dedicated bicycle travel lane 310, wherein the outer vehicle travel lane 322 is defined by the adjacent vehicle travel lane marker 321 and an outer vehicle travel lane marker 323. The cyclists travel along the dedicated bicycle travel lane 310. Vehicles 350, 354 travel along the adjacent vehicle travel lane 320 and outer vehicle travel lane 322. A width (distance between the roadway curb 302 and the dedicated bicycle travel lane marker 311) of the dedicated bicycle travel lane 310 is designed to provide a sufficient buffer between the cyclist and passing vehicles 350, 354. Unfortunately, there are occurrences where the cyclist, the passing vehicles 350, 354, or both travel across the dedicated bicycle travel lane marker 311, which can result in an accidental collision. The accidental collision can cause property damage and possible injury to the cyclist and or vehicle driver.

The visual environment sensing circuit (camera) 140 would capture images (step 416) of a rear approaching vehicle 350, wherein the captured images (video) are represented by an image collection 141. As shown, the visual environment sensing circuit (camera) 140 is oriented slightly towards the adjacent vehicle travel lane 320. The captured images would be analyzed using computer vision software to determine a relative position between the location of the visual environment sensing circuit (camera) 140 (or the calibrated location of the vehicle encroachment warning system 100) and the rear approaching vehicle 350. The computer vision software additionally determines the velocity (direction of travel and rate of speed) of the rear approaching vehicle 350.

The system can determine the velocity (direction of travel and rate of speed) of the vehicle encroachment warning system 100 (representative of the same of the bicycle 200) using the Global Positioning System (GPS) circuit 150. The microprocessor 130 analyzes the relative position between the location of the bicycle 200 and the rear approaching vehicle 350 in conjunction with the velocity of each of the bicycle 200 and rear approaching vehicle 350 to determine if there is a potential for an impending collision (step 420). In a condition where the vehicle encroachment warning system 100 employs a single environment sensing circuit, such as the visual environment sensing circuit (camera) 140, and the vehicle encroachment warning system 100 determines that the conditions of the rear approaching vehicle 350 are within a predetermined criteria, the vehicle encroachment warning system 100 initiates an alert system (step 432). The alert can be a visual alert, such as presenting a warning on the display 180, illuminating the visual alert 192, or presenting any other visual indicator to the cyclist. The alert can be an audible alert, such as emitting an audible signal through the audible alert 194. The audible signal can be a beep, a series of beeps, a continuous sound, a horn, a siren, a verbal warning, and the like. The vehicle encroachment warning system 100 would continue monitoring (step 434) the relative position between the location of the bicycle 200 and the rear approaching vehicle 350 in conjunction with the velocity of each of the bicycle 200 and rear approaching vehicle 350 to determine if the potential for an impending collision (step 420) is reduced below the predetermined criteria or eliminated (decision step 436). When the relative positions and velocities of the bicycle 200 and the rear approaching vehicle 350 no longer pose a potential threat, the vehicle encroachment warning system 100 deactivates or terminates the alert system (no shown). The vehicle encroachment warning system 100 determines whether to continue monitoring the environment for approaching vehicles that could pose a potential threat of a collision between the bicycle 200 and the rear approaching vehicle 350 (step 442). In a normal condition, the vehicle encroachment warning system 100 would return to the computer vision monitoring system (step 416). Under a condition where the vehicle encroachment warning system 100 determines that the monitoring process should be discontinued, the vehicle encroachment warning system 100 proceeds to terminate the monitoring process (step 404).

In an enhanced version, where the vehicle encroachment warning system 100 employs sequentially operating environment sensing circuits, such as the visual environment sensing circuit (camera) 140 and the radar environment sensing circuit 142. The first stage monitoring process would employ a general scanning acquisition device 140, such as a digital video camera. The second stage monitoring process would employ a second, more refined data acquisition device 142, such as a radar and/or laser based system. The radar environment sensing circuit 142 would acquire more accurate data associated with the position and velocity of the rear approaching vehicle 350. The two stage process enables a first stage providing a capability of monitoring vehicles across a broader environment while using less power, while, maintaining a highly accurate data acquisition system by activating the second stage monitoring process when required.

The vehicle encroachment warning system 100 determines that the conditions of the rear approaching vehicle 350 are within a predetermined criteria, the vehicle encroachment warning system 100 transfers the monitoring process from the first monitoring system (using the visual environment sensing circuit (camera) 140) to the second monitoring system (using the radar environment sensing circuit 142)(step 430). In a scenario where the vehicle encroachment warning system 100 determines that the conditions of the rear approaching vehicle 350 acquired using the radar environment sensing circuit 142 are within a predetermined criteria, the vehicle encroachment warning system 100 initiates an alert system (step 432).

The vehicle encroachment warning system 100 would continue monitoring the relative position between the location of the bicycle 200 and the rear approaching vehicle 350 in conjunction with the velocity of each of the bicycle 200 and rear approaching vehicle 350 using data acquired by the radar environment sensing circuit 142 to determine if the potential for an impending collision is within the predetermined criteria (similar to decision step 420). In a condition where the vehicle encroachment warning system 100 determines that the conditions of the rear approaching vehicle 350 are within a predetermined potential impending collision criteria, the vehicle encroachment warning system 100 initiates the alert system (step 432). This would be accomplished as described above. The monitoring and alerting process would continue as described above.

The method of operation could include an escalation process, such as a process described in the exemplary escalating impeding collision alert process flow diagram 500 presented in FIG. 5. The escalating impeding collision alert process flow diagram 500 initiates with an activation of a first environment sensing circuit, such as a visual environment sensing circuit (camera) 140.

The visual environment sensing circuit (camera) 140 would capture images of a rear approaching vehicle 350, wherein the captured images (video) are represented by an image collection 141. The captured images would be analyzed using computer vision software to determine a relative position between the location of the visual environment sensing circuit (camera) 140 (or the calibrated location of the vehicle encroachment warning system 100) and the rear approaching vehicle 350. The computer vision software additionally determines the velocity (direction of travel and rate of speed) of the rear approaching vehicle 350.

The system can determine the velocity (direction of travel and rate of speed) of the vehicle encroachment warning system 100 (representative of the same of the bicycle 200) using the Global Positioning System (GPS) circuit 150. The microprocessor 130 analyzes the relative position between the location of the bicycle 200 and the rear approaching vehicle 350 in conjunction with the velocity of each of the bicycle 200 and rear approaching vehicle 350 to determine if there is a potential for an impending collision (step 520).

When the vehicle encroachment warning system 100 determines that the conditions of the rear approaching vehicle 350 are within a predetermined possible collision criteria, and the system can optionally employ a secondary, more precise environment sensing circuit 142. The vehicle encroachment warning system 100 transfers the monitoring process from the first monitoring system (using the visual environment sensing circuit (camera) 140) to the second monitoring system (using the radar environment sensing circuit 142)(step 530). In a condition where the vehicle encroachment warning system 100 determines that the data representative of the location and velocity of the rear approaching vehicle 350 acquired using the radar environment sensing circuit 142 are within a predetermined potential impending collision criteria (step 531), the vehicle encroachment warning system 100 initiates a first level alert sequence (step 532). The first level alert sequence (step 532) would emit a low level alert to the user. The vehicle encroachment warning system 100 would continue monitoring the position and velocity of the rear approaching vehicle 350 respective to the position and velocity of the vehicle encroachment warning system 100 to determined if the relative data is within a predetermined warning criteria (step 550). In a condition where the vehicle encroachment warning system 100 determines that the relative data is within a predetermined warning criteria, the vehicle encroachment warning system 100 escalates the alert to a warning sequence (step 552). In a condition where the vehicle encroachment warning system 100 determines that the relative data is within the predetermined potential impending collision criteria (step 531), while remaining outside of the predetermined warning criteria, the vehicle encroachment warning system 100 maintains the alert to the low level alert (step 532) and the process returns to the object within the established alert criteria decision (step 531).

The vehicle encroachment warning system 100 would continue monitoring the position and velocity of the rear approaching vehicle 350 respective to the position and velocity of the vehicle encroachment warning system 100 to determined if the relative data is within a predetermined danger criteria (step 560). In a condition where the vehicle encroachment warning system 100 determines that the relative data is within a predetermined danger criteria, the vehicle encroachment warning system 100 escalates the alert to a danger alert sequence (step 562).

In a condition where the vehicle encroachment warning system 100 determines that the relative data is within the predetermined warning criteria (step 550), while remaining outside of the predetermined danger criteria, the vehicle encroachment warning system 100 maintains the alert to the warning level alert (step 552) and the process returns to the object within the established warning criteria decision (step 550).

In a condition where the vehicle encroachment warning system 100 determines that the relative data is within the predetermined potential impending collision criteria (step 531), while remaining outside of the predetermined warning criteria, the vehicle encroachment warning system 100 maintains the alert to the low level alert (step 532) and the process returns to the object within the established alert criteria decision (step 531).

In a condition where the vehicle encroachment warning system 100 determines that the data representative of the location and velocity of the rear approaching vehicle 350 acquired using the radar environment sensing circuit 142 are outside of the predetermined potential impending collision criteria (step 531), the vehicle encroachment warning system 100 cancels any active alerts (step 534), deactivates the second monitoring system (using the radar environment sensing circuit 142), and reactivates the first monitoring system (using the visual environment sensing circuit (camera) 140)(step 510). One exemplary condition where the rear approaching vehicle 350 would be outside of the predetermined potential impending collision criteria (step 531) would be where the rear approaching vehicle 350 passes the bicycle 200, becoming a passing vehicle 354, as shown in FIG. 3.

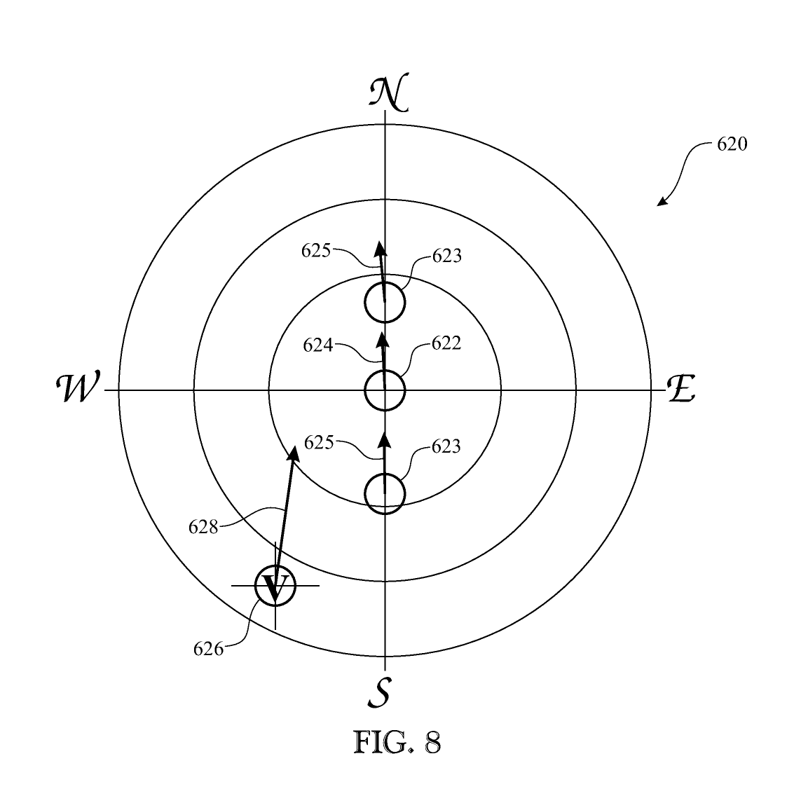

Details of the environmental conditions can be recorded and/or presented to the user. The environmental conditions can be shown upon the display 180, as illustrated in the exemplary data output arrangement shown in FIG. 7. A system controller 600 includes a display 680 and at least one system controller input element 614 supported by a system controller enclosure 610. The system controller 600 is exemplary of the vehicle encroachment warning system control unit 120. The system controller 600 would further comprise at least a portion of the elements of the vehicle encroachment warning system 100 illustrated in FIG. 2, including, but not limited to, the microprocessor 130, the digital memory 132, the Global Positioning System (GPS) circuit 150, the cellular communication circuit 160, the portable power supply 170, and the power/charging connector 172. The at least one system controller input element 614 provides an interface enabling the user to instruct or direct the operation of the system controller 600. The location of vehicles located in a vicinity of the vehicle encroachment warning system 100 are presented on a vehicle motion reference image 620. An enlarged, enhanced view of the vehicle motion reference image 620 is illustrated in FIG. 8. The vehicle motion reference image 620 centers about a base location referred to as a system location reference indicator 622, wherein the system location reference indicator 622 coincides with the location of the vehicle encroachment warning system 100 (or calibrated to a central location of the bicycle 200). The vehicle motion reference image 620 can include a series of circles or rings spaced representing preset or scalable distances. The vehicle motion reference image 620 can include a directional reference provided in a form of crossing lines. The directional references can be related to the four cardinal directions or cardinal points are the directions of north, east, south, and west, commonly denoted by their initials: N, E, S, W (as shown). Alternatively, the directional references can be related to the actual direction of travel, wherein the upper vertical line would remain in alignment with the direction of travel of the vehicle encroachment warning system 100 (being representative of the direction of travel of the bicycle 200).

The vehicle motion reference image 620 presented in FIG. 8 is preferably centered about a system location reference indicator 622, which is indicative of the location of the bicycle 200 or other object having the vehicle encroachment warning system 100 attached thereto. The velocity of the subject bicycle 200 or other object having the vehicle encroachment warning system 100 attached thereto is identified by a system velocity indicator 624, wherein the system velocity indicator 624 is a graphical representation of the speed (length of the arrow) and direction (orientation of the arrow). The vehicle motion reference image 620 presented in FIG. 8 additionally identifies the rear approaching vehicle 350 (identified as an approaching vehicle relative location reference indicator 626) at a location relative to the location of the vehicle encroachment warning system 100. The velocity of the rear approaching vehicle 350 is illustrated as an approaching vehicle relative velocity indicator 628, wherein the approaching vehicle relative velocity indicator 628 is a graphical representation of the speed (length of the arrow) and direction (orientation of the arrow). The vehicle motion reference image 620 presented in FIG. 8 additionally identifies a position of two bicycles 200 (identified by an adjacent cyclist location reference indicator 623) riding in a vicinity of the user of the vehicle encroachment warning system 100 respective to the position of the user of the vehicle encroachment warning system 100 (identified by a system location reference indicator 622). The velocity of each bicycle 200 riding in a vicinity of the user of the vehicle encroachment warning system 100 is identified by an adjacent cyclist system velocity indicator 625, wherein the adjacent cyclist system velocity indicator 625 is a graphical representation of the speed (length of the arrow) and direction (orientation of the arrow).

The system controller 600 can record and present additional information to the user, including:
a. still images or real time video of the rear approaching vehicle 350 (referenced as an approaching vehicle image 650);
b. a approaching vehicle license plate 652 identifying the rear approaching vehicle 350 when available,
c. telemetry information of the rear approaching vehicle 350, including a distance between the rear approaching vehicle 350 and the vehicle encroachment warning system 100 (identified as an approaching vehicle relative location information 636),
d. a velocity of the rear approaching vehicle 350, including a heading or direction of travel and a rate of speed thereof, collectively identified as an approaching vehicle relative velocity information 638),
e. system location information, such as Global Positioning System (GPS) Coordinates (identified as system location coordinates 632),
f. telemetry information of the vehicle encroachment warning system 100 (being representative of the telemetry information of the bicycle 200), including a heading or direction of travel and a rate of speed thereof, collectively identified as a system velocity information 634);
g. real time information, including a time stamp (in 12 or 24 hour format) and a date (collectively identified as an image recording time stamp information 640);
h. weather conditions, such as rain, sunshine, hail, snow, ice, sleet, wind, cloudy, and any other descriptive weather condition, as well as quantitative information, such as temperature (in either Celsius or Fahrenheit), humidity, and the like (collectively identified as a current weather conditions 642); and
i. lighting conditions (identified as a current lighting conditions 644).

It is understood that the above described metrics and other data are only exemplary and the vehicle encroachment warning system 100 can display these and/or other images, metrics and other data as deemed to be appropriate.

In an enhanced version, the vehicle encroachment environment sensing system 110 is replaced by a dual camera rear facing environment monitoring system 112, as illustrated in FIG. 9. The dual camera rear facing environment monitoring system 112 includes a pair of spatially arranged cameras. The spatial arrangement introduces a stereo vision capability to enhance depth perception or the ability to determine the distance between the rear approaching vehicle 350 and the vehicle encroachment warning system 100. A first visual environment sensing circuit (camera) 140 of the dual camera rear facing environment monitoring system 112 would acquire a first rear facing image collection 146. A second visual environment sensing circuit (camera) 140 of the dual camera rear facing environment monitoring system 112 would acquire a second rear facing image collection 147. The pair of images would be analyzed to aid in determining the distance between the rear approaching vehicle 350 and the vehicle encroachment warning system 100. Each visual environment sensing circuit (camera) 140 would preferably include an autofocus feature. The focal distance could be one of the data points included in the analysis in determining the distance between the rear approaching vehicle 350 and the vehicle encroachment warning system 100.

Another enhancement introduces a forward facing environment monitoring system 114, as illustrated in FIG. 9. Details of the installation of the forward facing environment monitoring system 114 are described above. Certain circumstances would introduce a desire to capture forward looking images. Certain states do not require a front mounted license plate. One desirable reason to capture forward looking images would be to acquire an image of the passing vehicle license plate 358 associated with the passing vehicle rear end 356 as illustrated in FIG. 3. The forward facing environment monitoring system 114 enables capture of forward looking images 148. This would be used to acquire images of a passing vehicle rear end 356 of a passing vehicle 354. The image of the passing vehicle rear end 356 would include an image of the passing vehicle license plate 358. The vehicle encroachment warning system 100 could include a feature which utilizes optical character recognition to convert an image of the license plate to an ASCII code or text representation. This information could be used for any suitable purpose, such as identification of a dangerous driver, and the like.

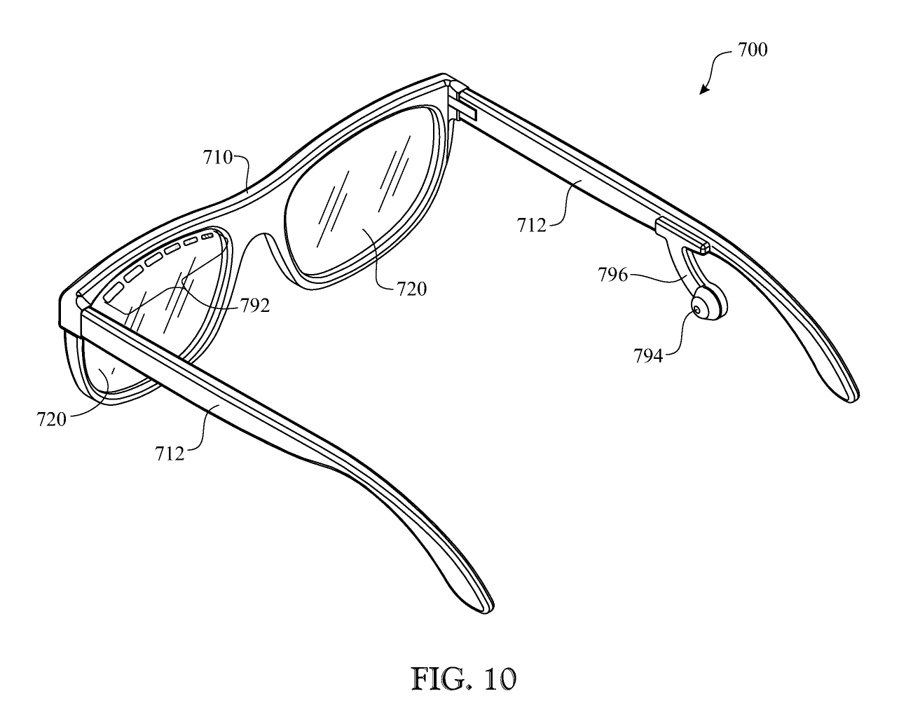

The vehicle encroachment warning system 100 can be adapted for use by a pedestrian 800, as illustrated in FIGS. 10 and 11. The pedestrian 800 normally walks, jogs, or runs on the sidewalk 305. The pedestrian 800 would wear an rear facing environment monitoring system 810 on their arm or other suitable body location and an alert enabled eyewear 700 on their head. The rear facing environment monitoring system 810 includes the necessary elements of the vehicle encroachment warning system 100 for acquisition of images of a rear approaching object, including another pedestrian, a bicycle 200, a rear approaching vehicle 350, or any other object that may be of interest to the pedestrian 800. The rear facing environment monitoring system 810 may be a custom fabricated device, an application running on a Smartphone (900 of FIG. 14), or a combination thereof. The alert enabled eyewear 700 and rear facing environment monitoring system 810 would be in wired or preferably wireless communication with one another.

The alert enabled eyewear 700 would include features commonly found in commercially available eyewear. The alert enabled eyewear 700 is adapted to include at least one alert component. The alert enabled eyewear 700 includes a pair of eyewear temples 712, wherein each eyewear temple 712 is hingeably assembled to a respective distal end of the eyewear frame 710. A pair of eyewear lenses 720 are assembled to the eyewear frame 710. In the exemplary embodiment, the alert enabled eyewear 700 includes a visual alert 792 and an audible alert 794. The visual alert 792 can be integrated into the lens (as shown), the eyewear frame 710, or any other suitable feature wherein the visual alert 792 would be located within a peripheral viewing range of the pedestrian 800. The alert enabled eyewear 700 could include at least one audible alert 794. Each audible alert 794 would be mounted directly to the eyewear temple 712 or mounted indirectly to the eyewear temple 712 by way of an audible alert support bracket 796, locating an audio output region of the audible alert 794 proximate the respective ear of the pedestrian 800. In a wireless communication configuration, the alert enabled eyewear 700 would include a transceiver, a microprocessor, and a portable power supply providing operational support thereof. In a wired communication configuration, power and signal communication could be provided through the wires or cabling extending between the alert enabled eyewear 700 and the rear facing environment monitoring system 810.

The rear facing environment monitoring system 810 would be oriented to acquire images of rear approaching objects. The rear facing environment monitoring system 810 can be temporarily secured to an upper arm of the pedestrian 800 using a vehicle encroachment warning system housing mounting band 822. Alternatively, the rear facing environment monitoring system 810 can be attached to a rear panel of an article of clothing, such as a shirt, a jacket, a vest, a safety vest, a belt, and the like. The rear facing environment monitoring system 810 would operate in a manner similar to the operation of the vehicle encroachment warning system 100 described above. The rear facing environment monitoring system 810 would acquire an image, being represented by an image collection 841. The rear facing environment monitoring system 810 processes the captured or collected image 841 to determine if an alert, a warning, or a dangerous condition may be impending. The rear facing environment monitoring system 810 would provide instructions to the alert enabled eyewear 700 to activate, escalate as required, and deactivate each integrated alert 792, 794 to alert the pedestrian 800 to be aware of an impending situation. The pedestrian 800 would become aware of the activated alert and act accordingly.

The vehicle encroachment warning system 100 can be adapted for use on an encroaching vehicle application enabled Smartphone 900, as illustrated in FIGS. 12 through 16. The integrated features of the encroaching vehicle application enabled Smartphone 900 offers a variety of configurations for inclusion of the encroaching vehicle application enabled Smartphone 900 within a vehicle encroachment warning system. The vehicle encroachment warning system can utilize the encroaching vehicle application enabled Smartphone 900 as a control unit, a visual environment sensing circuit (camera), a unit location and velocity sensing system, a user alert function, one or more communication functions, Internet access, a light sensing, a power source, and the like.

As previously mentioned, a number of the components of the vehicle encroachment warning system 100 and encroaching vehicle application enabled Smartphone 900 are similar, wherein like components of the vehicle encroachment warning system 100 and encroaching vehicle application enabled Smartphone 900 are numbered the same except proceeded by the number “1” or “9” respectively. The components would be assembled within or onto a Smartphone housing 920. The encroaching vehicle application enabled Smartphone 900 includes several additional features, including a pair of integrated cameras 940, 941, a plurality of speakers 994, 995, a headphone jack 936, a motion detector 952, an environment ambient light sensor 954 and a user interface input button 982. The encroaching vehicle application enabled Smartphone 900 additionally includes a plurality of wireless communication circuits, including a cellular communication circuit 960, a Bluetooth communication circuit 962, a Wi-Fi communication circuit 964, and more recent models include a Near Filed Communication (NFC) circuit 966.

The introduction and integration of the encroaching vehicle application enabled Smartphone 900 within the vehicle encroachment warning system provides a number of enhancements over a custom controller unit. Initially, most people currently carry Smartphones with them. Therefore, the cost of deployment of the vehicle encroachment warning system is reduced. The integrated features provides additional functionality.

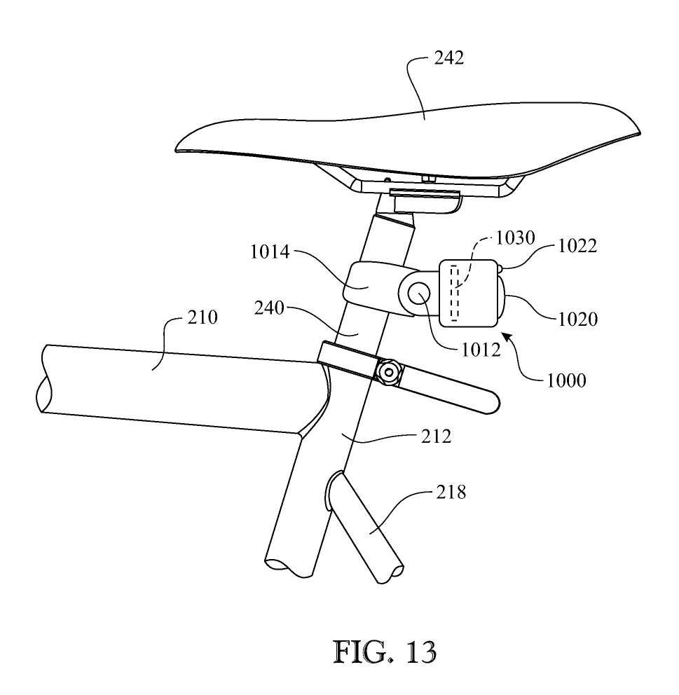

In one exemplary configuration, the encroaching vehicle application enabled Smartphone 900 is designated as a central control unit and a rear facing remote camera 1000 is provided for image acquisition, as illustrated in FIGS. 12 and 13. In the illustrated example, the encroaching vehicle application enabled Smartphone 900 is inserted into a Smartphone holster 921, which is secured to the handlebar 250 or the handlebar stem 252 by a Smartphone holster bracket 922. The Smartphone holster 921 and Smartphone holster bracket 922 preferably includes features enabling the user to optimize the orientation of the encroaching vehicle application enabled Smartphone 900 for use. It is understood that the encroaching vehicle application enabled Smartphone 900 can be mounted to the bicycle 200 at any suitable location, preferably being visible to and within reach of the rider/cyclist.

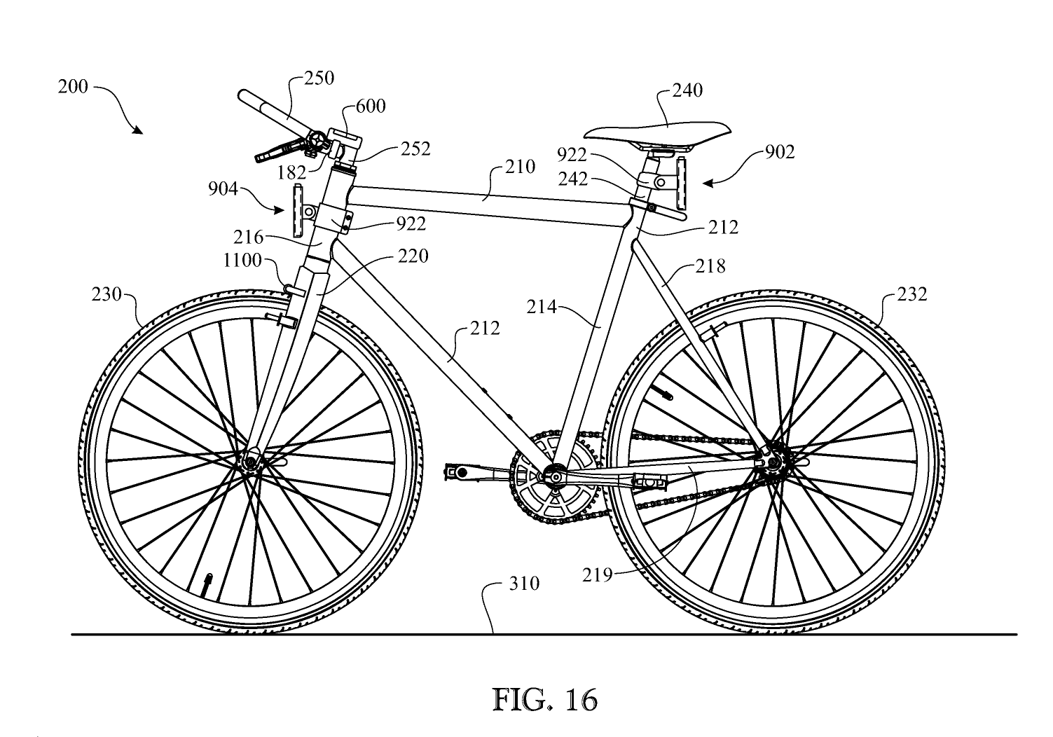

Features of the rear facing remote camera 1000 are best shown in FIG. 16. The rear facing remote camera 1000 includes a camera 1020 assembled within a remote camera housing 1010. A camera mounting bracket arm 1012 is either integrated into the design of the remote camera housing 1010 and fabricated as a unitary molded component or designed as a separate component, fabricated accordingly and subsequently assembled to the remote camera housing 1010. An optional first light 1022 and/or an optional second light 1024 can be integrated into the rear facing remote camera 1000, providing lighting for use during dusk or dark timeframes to inform others of the presence of the user, for use as image capture lighting, for use as a turn indicator, a brake light, or any other suitable function. Each of the optional first light 1022 and the optional second light 1024 can be of similarly colored lights, different colored lights, multi-colored lights enabling emission of different colored lights, and the like. Functioning of the optional first light 1022 and optional second light 1024 would be controlled by an integrated processor and/or the microprocessor 930 of the encroaching vehicle application enabled Smartphone 900. The function could illuminate the optional first light 1022 and the optional second light 1024 as a continuous fixed colored light emission, a continuous selected colored light emission, selected from a plurality of available colors available from a multi-colored illuminating element, a flashing fixed colored light emission, a flashing selected colored light emission, selected from a plurality of available colors available from a multi-colored illuminating element, a differing light intensity, or any other suitable light emission. The inclusion of both, the optional first light 1022 and the optional second light 1024 enables the use of the optional first light 1022 and the optional second light 1024 as a turn indicator system. An optional communication circuit 1030 can be integrated into the remote camera 1000, 1002, wherein the optional communication circuit 1030 provides wireless communication between the remote camera 1000, 1002 and the system controller 600 or encroaching vehicle application enabled Smartphone 900.

In the illustrated example, the rear facing remote camera 1000 is secured to the bicycle 200 in a rearward facing orientation by securing a camera mounting bracket clamp 1014 to the seat post 242, then assembling the camera mounting bracket arm 1012 to the camera mounting bracket clamp 1014. The rotational mounting design of the camera mounting bracket clamp 1014 and the interface between the camera mounting bracket arm 1012 and the camera mounting bracket clamp 1014 enables positional adjustability or aiming of the rear facing remote camera 1000. The rear facing remote camera 1000 could optionally be angled slightly towards the street (right side of the camera in a right side drive country/left side of the camera in a left side drive country). The rear facing remote camera 1000 is drawn oversized for clarity. The target design would be a lipstick sized casing that would be mounted in any suitable location, such as to an underside or support frame of the seat or saddle 240, a small bracket mounted to threaded inserts carried by the bicycle frame down tube section 212, between the pair of bicycle frame seat stay section 218, or any other suitable location. The rear facing remote camera 1000 would be in operational communication with the encroaching vehicle application enabled Smartphone 900 using ether a wired or wireless communication link. When using a wired communication link, the wires or cabling can be routed externally or concealed, routing the wires or cabling through the hollow interior of the tubular sections.

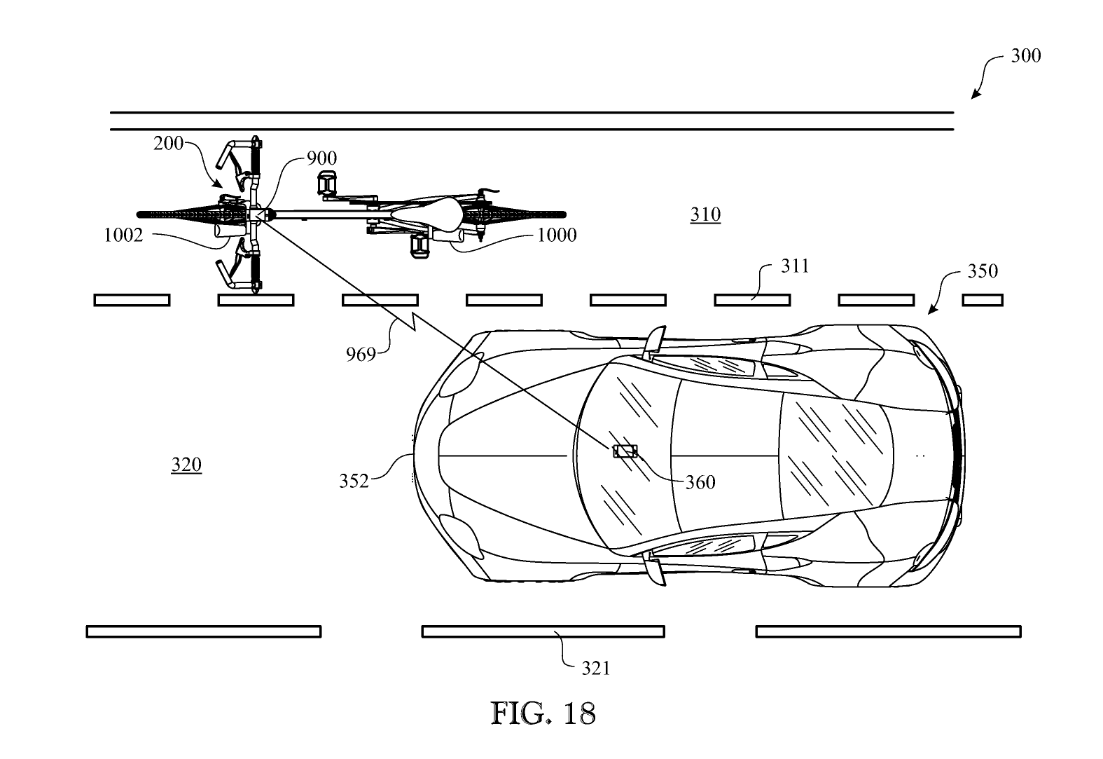

The exemplary configuration would operate in accordance with the escalating impeding collision alert process flow diagram 500 and/or alert enabled eyewear 700 described above. The user would install an application onto the encroaching vehicle application enabled Smartphone 900. When initiating the ride, the user would activate the associated application. The application could utilize the motion detector 952 to activate and deactivate the environmental vehicle monitoring components of the system to reduce memory requirements and power consumption. The display 980 is generally provided as a touch screen, providing an interactive user interface. The system can utilize this feature and present various changing graphical user interfaces (GUI's) to maximize the system functionality, ease of use, and the overall user's experience. The various communication links, including a cellular communication circuit 960, a Bluetooth communication circuit 962, a Wi-Fi communication circuit 964, and a Near Filed Communication (NFC) circuit 966 offer different communication protocols to convey instructions, data, or other information between the encroaching vehicle application enabled Smartphone 900 and remote transceivers. One advantage of the ability to communicate with other vehicles in the vicinity thereof is presented in FIG. 18, wherein the encroaching vehicle application enabled Smartphone 900 can convey information, via a wireless communication link 969, to a vehicle communications transceiver 360 located within the rear approaching vehicle 350, carried by another rider on another bicycle 200, or any other application in the proximity thereof. The vehicle communications transceiver 360 can be another Smartphone, a dedicated transceiver, a scanning device to receive one way transmissions, and the like. The vehicle communications transceiver 360 can be a portable device or integrated into the service features of the vehicle. The encroaching vehicle application enabled Smartphone 900 to vehicle communications transceiver 360 communications enables conveyance of alerts or warnings to each of the user and any other rider or driver located in the vicinity thereof. Using a bi-directional communication further enhances the opportunities, wherein the messaging can be directed towards a specific driver or rider to warn them of a potential impending collision. The system can alternatively simple emit a beacon broadcasting signal to warn others of the rider/cyclist using the encroaching vehicle application enabled Smartphone 900 integrated into the vehicle encroachment warning system 100.

In the illustrated example further comprises an optional forward facing remote camera 1002. The optional forward facing remote camera 1002 illustrated in the example, is secured to the bicycle frame head tube section 216 in a forward facing orientation by another camera mounting bracket clamp 1014, then assembling the camera mounting bracket arm 1012 to the camera mounting bracket clamp 1014. The rotational mounting design of the camera mounting bracket clamp 1014 and the interface between the camera mounting bracket arm 1012 and the camera mounting bracket clamp 1014 enables positional adjustability or aiming of the forward facing remote camera 1002. The forward facing remote camera 1002 could optionally be angled slightly towards the street (left side of the camera in a right side drive country/right side of the camera in a left side drive country). Like the rear facing remote camera 1000, the forward facing remote camera 1002 is drawn oversized for clarity. The target design would be a lipstick sized casing that would be mounted in any suitable location using a small bracket mounted to threaded inserts carried by the bicycle frame head tube section 216, the bicycle frame top tube section 210, the handlebar 250, the handlebar stem 252, either side of the bicycle frame fork assembly 220, or any other suitable location. The forward facing remote camera 1002 would be in operational communication with the encroaching vehicle application enabled Smartphone 900 using ether a wired or wireless communication link. When using a wired communication link, the wires or cabling can be routed externally or concealed, routing the wires or cabling through the hollow interior of the tubular sections.

The forward facing remote camera 1002 can be activated by the controller unit and/or the user. The forward facing remote camera 1002 is provided to acquire images of vehicles passing or forward of the system. This would be helpful when needing to identify a vehicle of interest following a specific event, such as an evasive maneuver, a collision, and the like. One additional feature is the ability to acquire an image of a license plate 358. License plates are required on the rear end 356 of each vehicle 354 in all states, but only required on the front end 352 of each vehicle 350 in a select number of states. Therefore, images collected of the front end 352 of each vehicle 350 may or may not include an image of the passing vehicle license plate 358. The inclusion of the forward facing remote camera 1002 increases the likelihood of acquiring an image of the passing vehicle license plate 358. The inclusion of the forward facing remote camera 1002 acquires additional images of the rear approaching vehicle 350 as the rear approaching vehicle 350 passes the bicycle 200, subsequently identified as a passing vehicle 354. The collected additional images offers more information for identifying the specific vehicle of interest. This can include, the make, model, model year, color, multiple colors, any customization, any specific damage unique to that vehicle, and the like.

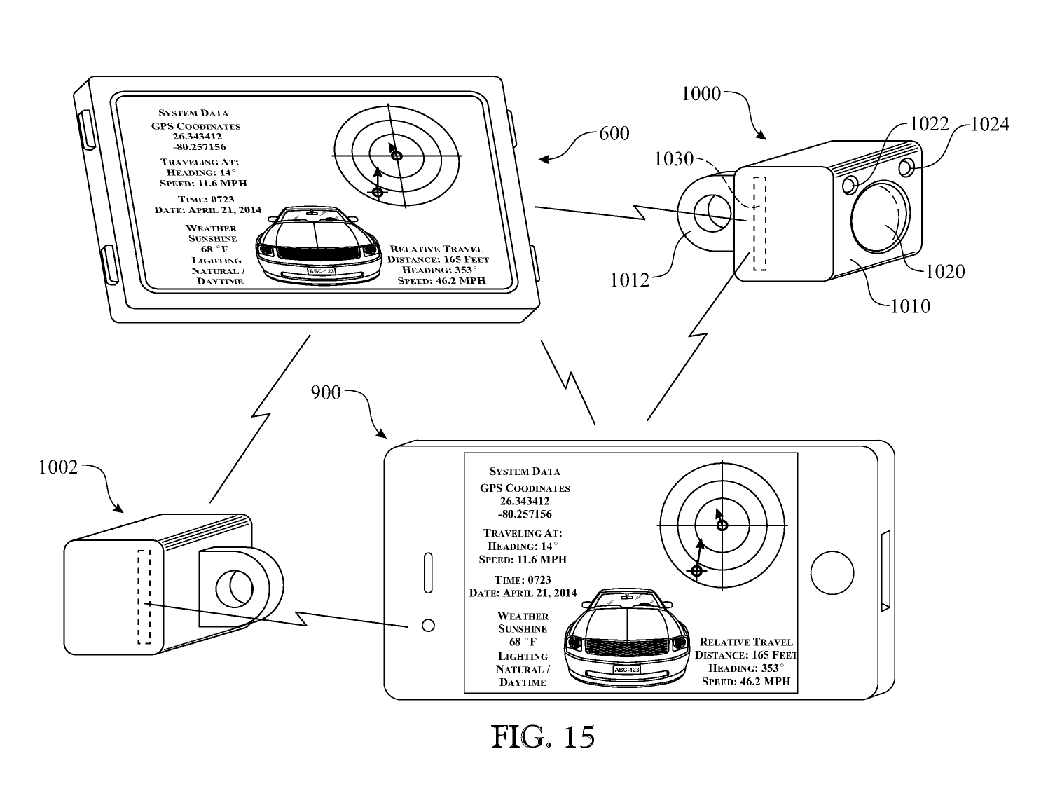

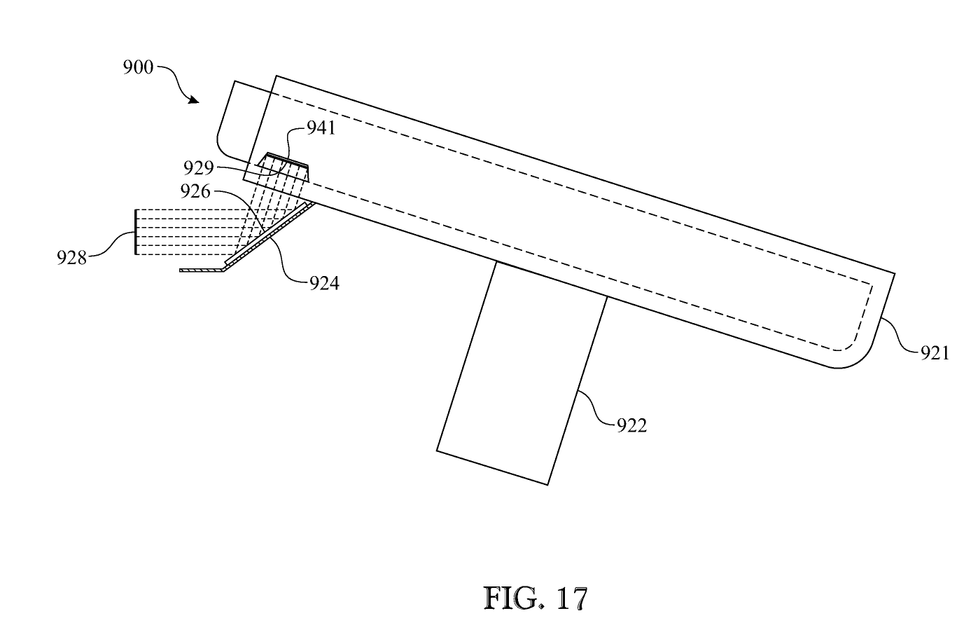

The vehicle encroachment warning system can be designed and installed in any of a variety of configurations. Examples of the suggested available subassemblies are illustrated in FIG. 15. The suggested available subassemblies include the system controller 600, the rear facing remote camera 1000 (or the vehicle encroachment environment sensing system 110 (not shown) of FIGS. 1, 3, and 6 or the dual camera rear facing environment monitoring system 112 (not shown) of FIG. 9), the optional forward facing remote camera 1002 (or the forward facing environment monitoring system 114 (not shown) of FIG. 9), and the encroaching vehicle application enabled Smartphone 900. The rear facing remote camera 1000 and the forward facing remote camera 1002 are preferably the same device, with the distinction simply being the mounted orientation. Although the rear facing remote camera 1000 is illustrated having a single camera 1020, it is understood that the rear facing remote camera 1000 can include a pair of spatially arranged cameras 1020. The system could use one or more of each subassembly. The vehicle encroachment warning system can additionally include mounting components, such as a Smartphone holster 921 and a Smartphone holster bracket 922 (shown in FIG. 17), cabling and/or wiring, power chargers for recharging portable power supplies 170, 970, and any other components required for installation and utilization of the system.

A first configuration would employ one (1) system controller 600 used as a control unit and one (1) vehicle encroachment environment sensing system 110 to acquire digital images of objects approaching from the rear, as shown in FIGS. 1, 3, and 6.

A second configuration would employ one (1) system controller 600 used as a control unit and one (1) dual camera rear facing environment monitoring system 112 to acquire digital images of objects approaching from the rear, as shown in FIG. 9.

A third configuration would employ one (1) system controller 600 used as a control unit, one (1) vehicle encroachment environment sensing system 110 to acquire digital images of objects approaching from the rear, as shown in FIGS. 1, 3, and 6, and one (1) forward facing environment monitoring system 114 to acquire digital images of objects in front of the system as shown in FIG. 9.

A fourth configuration would employ one (1) system controller 600 used as a control unit, one (1) dual camera rear facing environment monitoring system 112 to acquire digital images of objects approaching from the rear, as shown in FIG. 9, and one (1) forward facing environment monitoring system 114 to acquire digital images of objects in front of the system as shown in FIG. 9.

A fifth configuration would employ one (1) encroaching vehicle application enabled Smartphone 900 used as a control unit and one (1) rear facing remote camera 1000 to acquire digital images of objects approaching from the rear, as shown in FIG. 12.

A sixth configuration would employ one (1) encroaching vehicle application enabled Smartphone 900 used as a control unit, one (1) rear facing remote camera 1000 mounted and oriented to the bicycle 200 for acquiring digital images of objects approaching from the rear, and one (1) forward facing remote camera 1002 mounted and oriented to the bicycle 200 for acquiring digital images of objects in front of the system.

A seventh configuration would employ one (1) system controller 600 used as a control unit and one (1) encroaching vehicle application enabled Smartphone 900 (identified as a rearward oriented encroaching vehicle application enabled Smartphone 902) mounted and oriented to the bicycle 200 for acquiring digital images of objects approaching from the rear, as shown in FIG. 16. The rearward oriented encroaching vehicle application enabled Smartphone 902 would be secured to the bicycle 200 using any suitable attachment elements. In the exemplary illustration, a Smartphone holster 921 (FIG. 17) and an associated Smartphone holster bracket 922 (FIG. 17) are used to temporarily secure the rearward oriented encroaching vehicle application enabled Smartphone 902 to the bicycle 200.

An eighth configuration would employ one (1) system controller 600 used as a control unit and two (2) encroaching vehicle application enabled Smartphones 900, a first (identified as a rearward oriented encroaching vehicle application enabled Smartphone 902) mounted and oriented to the bicycle 200 for acquiring digital images of objects approaching from the rear and a second (identified as a forward oriented encroaching vehicle application enabled Smartphone 904) mounted and oriented to the bicycle 200 for acquiring digital images of objects in front of the system, as shown in FIG. 16. The rearward oriented encroaching vehicle application enabled Smartphone 902 and forward oriented encroaching vehicle application enabled Smartphone 904 would be secured to the bicycle 200 using any suitable attachment elements. In the exemplary illustration, a Smartphone holster 921 (FIG. 17) and an associated Smartphone holster bracket 922 (FIG. 17) are used to temporarily secure the rearward oriented encroaching vehicle application enabled Smartphone 902 and the forward oriented encroaching vehicle application enabled Smartphone 904 to the bicycle 200.

The following configurations are not illustrated, but well understood by the other illustrations provided in conjunction with this specification.

A ninth configuration would employ one (1) system controller 600 used as a control unit, one (1) encroaching vehicle application enabled Smartphone 900, and one (1) forward facing remote camera 1002. The encroaching vehicle application enabled Smartphone 900 (identified as a rearward oriented encroaching vehicle application enabled Smartphone 902) would be mounted and oriented for acquiring digital images of objects approaching from the rear (as shown in FIG. 16) and one (1) forward facing remote camera 1002 mounted and oriented to the bicycle 200 for acquiring digital images of objects in front of the system (as shown in FIG. 12).

A tenth configuration would employ one (1) encroaching vehicle application enabled Smartphone 900 used as a control unit, one (1) encroaching vehicle application enabled Smartphone 900, and one (1) forward facing remote camera 1002. The encroaching vehicle application enabled Smartphone 900 (identified as a rearward oriented encroaching vehicle application enabled Smartphone 902) would be mounted and oriented for acquiring digital images of objects approaching from the rear (as shown in FIG. 16) and one (1) forward facing remote camera 1002 mounted and oriented to the bicycle 200 for acquiring digital images of objects in front of the system (as shown in FIG. 12).

An eleventh configuration would employ one (1) system controller 600 used as a control unit, one (1) encroaching vehicle application enabled Smartphone 900, and one (1) rear facing remote camera 1000. The rear facing remote camera 1000 would be mounted and oriented for acquiring digital images of objects approaching from the rear (as shown in FIG. 12) and one (1) encroaching vehicle application enabled Smartphone 900 (identified as a forward oriented encroaching vehicle application enabled Smartphone 904) mounted and oriented to the bicycle 200 for acquiring digital images of objects in front of the system (as shown in FIG. 16).

A twelfth configuration would employ one (1) encroaching vehicle application enabled Smartphone 900 used as a control unit, one (1) encroaching vehicle application enabled Smartphone 900, and one (1) rear facing remote camera 1000. The rear facing remote camera 1000 would be mounted and oriented for acquiring digital images of objects approaching from the rear (as shown in FIG. 12) and one (1) encroaching vehicle application enabled Smartphone 900 (identified as a forward oriented encroaching vehicle application enabled Smartphone 904) mounted and oriented to the bicycle 200 for acquiring digital images of objects in front of the system (as shown in FIG. 16).

Additional features could be employed to further enhance capabilities and options for the system.

For example, the encroaching vehicle application enabled Smartphone 900 is preferably mounted having a horizontal orientation to reduce wind resistance, while optimizing the viewing and ability to contact the encroaching vehicle application enabled Smartphone 900 by the user. This orientation directs the first facing camera 940 upward and the second facing camera 941 downward, towards the surface of the road or other riding surface. A Smartphone camera image diverter 924 can be included with the Smartphone holster 921, as illustrated in FIG. 17. The Smartphone camera image diverter 924 is designed to redirect a focal position of the second facing camera 941 towards the desired image 928 by including a Smartphone camera image diverter mirror 926 within the Smartphone camera image diverter 924. The Smartphone camera image diverter mirror 926 would be properly angled to redirect the second facing camera 941 as desired. The Smartphone camera image diverter 924 can include features enabling positional and/or angular adjustment of the Smartphone camera image diverter mirror 926 respective to the second facing camera 941 and the image 928. Once optimized, the Smartphone camera image diverter mirror 926 redirects or reflects an image of the image 928 onto the second facing camera 941, wherein the acquired image is identified as a captured digital image 929. It is noted that the resulting captured digital image 929 would be inverted respective to the image 928. Image processing would invert the captured digital image 929 into the proper orientation. This feature would enable the encroaching vehicle application enabled Smartphone 900 to function as the control unit, be mounted as described, and acquire images forward of the system.

The above disclosure describes a generic vehicle encroachment warning system and a variety of suggested configurations. Although the disclosure describes a number of suggested configurations, it is understood that the disclosed suggested configurations are only exemplary and that the system can be deployed in other configurations while maintaining the same spirit and intent of the subject invention. It is considered that the above described system can be modified, altered or reconfigured to achieve the same functionality as understood by those skilled in the art.

Another advantage of the integration of the encroaching vehicle application enabled Smartphone 900 is an integrated ability to access the Internet. Internet access offers a number of enhancements. A first example of an enhancement is the ability to acquire weather conditions in the vicinity of the user. A second example of an enhancement is the ability to acquire sunrise and/or sunset times, enabling the user to plan for adequate lighting conditions. A third example of an enhancement is the ability to upload acquired data to a remote storage location. A fourth example of an enhancement is the ability to obtain traffic conditions and alert the user accordingly. A fifth example of an enhancement is the ability to obtain directions along a course and present travel directions or navigation to the user.

The above-described embodiments are merely exemplary illustrations of implementations set forth for a clear understanding of the principles of the invention. Many variations, combinations, modifications or equivalents may be substituted for elements thereof without departing from the scope of the invention. Therefore, it is intended that the invention not be limited to the particular embodiments disclosed as the best mode contemplated for carrying out this invention, but that the invention will include all the embodiments falling within the scope of the appended claims.

### ELEMENT DESCRIPTION REFERENCES

### Ref. No. Description

100 vehicle encroachment warning system
110 vehicle encroachment environment sensing system
112 dual camera rear facing environment monitoring system
114 forward facing environment monitoring system
120 vehicle encroachment warning system control unit
122 vehicle encroachment warning system housing mounting bracket
124 dual camera vehicle encroachment warning system housing mounting bracket
130 microprocessor
132 digital memory
134 interface connector
140 visual environment sensing circuit (camera)
141 image collection
142 radar environment sensing circuit
146 first rear facing image collection
147 second rear facing image collection
148 forward facing image collection
150 Global Positioning System (GPS) circuit
160 cellular communication circuit
161 e-autodial circuit
170 portable power supply
172 power/charging connector
180 display
182 display mount subsystem
190 alert system
192 visual alert
194 audible alert
200 bicycle
210 bicycle frame top tube section
212 bicycle frame down tube section
214 bicycle frame seat tube section
216 bicycle frame head tube section
218 bicycle frame seat stay section
219 bicycle frame chain stay section
220 bicycle frame fork assembly
230 front tire and wheel assembly
232 rear tire and wheel assembly
240 seat or saddle
242 seat post
250 handlebar
252 handlebar stem
300 exemplary roadway scenario
302 roadway curb
305 sidewalk
310 dedicated bicycle travel lane
311 dedicated bicycle travel lane marker
320 adjacent vehicle travel lane
321 adjacent vehicle travel lane marker
322 outer vehicle travel lane
323 outer vehicle travel lane marker
350 rear approaching vehicle
352 rear approaching vehicle front end
354 passing vehicle
356 passing vehicle rear end
358 passing vehicle license plate
360 vehicle communications transceiver
400 monitoring system flow diagram
402 initiation step
404 termination step
410 encroaching vehicle monitoring system installation step
412 activate computer vision (CV) based monitoring system
414 initiate bicycle ride step
416 active monitoring for potential impending collision using computer vision step
420 object within predetermined criteria decision step
430 activate secondary monitoring system step
432 initiate alert system
434 monitor and analyze approaching vehicle and set alert accordingly step
440 object no longer considered a potential threat decision step
442 terminate monitoring system operation step
500 escalating impeding collision alert process flow diagram
510 computer vision monitoring step
520 object within predetermined criteria as determined by initial monitoring system decision step
530 activate secondary monitoring system step
532 initiate alert sequence step
534 cancel alert sequence step
536 deactivate secondary monitoring system step
550 object within predetermined criteria as determined by secondary monitoring system decision step
552 initiate warning alert sequence step
560 object within predetermined danger criteria as determined by secondary monitoring system decision step
562 initiate danger alert sequence step
600 system controller
610 system controller enclosure
614 system controller input element
620 vehicle motion reference image
622 system location reference indicator
623 adjacent cyclist location reference indicator
624 system velocity indicator
625 adjacent cyclist system velocity indicator
626 approaching vehicle relative location reference indicator
628 approaching vehicle relative velocity indicator
632 system location coordinates
634 system velocity information
636 approaching vehicle relative location information
638 approaching vehicle relative velocity information
640 image recording time stamp information
642 current weather conditions
644 current lighting conditions
650 approaching vehicle image
652 approaching vehicle license plate
680 display
700 alert enabled eyewear
710 eyewear frame
712 eyewear temple
720 eyewear lens
792 visual alert
794 audible alert
796 audible alert support bracket
800 pedestrian
810 rear facing environment monitoring system
822 vehicle encroachment warning system housing mounting band
841 image collection
900 encroaching vehicle application enabled Smartphone
902 rearward oriented encroaching vehicle application enabled Smartphone
904 forward oriented encroaching vehicle application enabled Smartphone
920 Smartphone housing
921 Smartphone holster
922 Smartphone holster bracket
924 Smartphone camera image diverter
926 Smartphone camera image diverter mirror
928 image
929 captured digital image
930 microprocessor
932 digital memory device
934 interface connector
936 headphone jack
940 first facing camera
941 second facing camera
950 Global Positioning System (GPS) circuit
952 motion detector
954 environment ambient light sensor
960 cellular communication circuit
961 emergency auto dialer
962 Bluetooth communication circuit
964 Wi-Fi communication circuit
966 Near Filed Communication (NFC) circuit
969 wireless communication link
970 portable power supply
980 display
982 user interface input button
994 distal speaker
995 proximity speaker
1000 rear facing remote camera
1002 forward facing remote camera
1010 remote camera housing
1012 camera mounting bracket arm
1014 camera mounting bracket clamp
1020 camera
1022 optional first light
1024 optional second light
1030 communication circuit
1100 electrical power generator

What is claimed is:

1. An encroaching vehicle monitoring and alerting system, comprising:
a Smartphone operating in accordance with an application as a controller unit, said Smartphone comprising:
a microprocessor, wherein said microprocessor is operated in accordance with an operational instruction set,
a digital memory device in signal communication with said microprocessor,
a display in operational communication with said microprocessor,
a cellular-based communication circuit,
a Smartphone location sensing circuit in signal communication with said microprocessor, wherein the system motion sensing circuit is used to determine a location and a motion of the controller unit,
a portable power supply, and
a Smartphone housing containing said microprocessor and said system motion sensing system motion sensing circuit;
an approaching object sensing system secured to a subject object, the approaching object sensing system is in signal communication with the microprocessor, wherein the approaching object sensing system is oriented to sense at least one monitored object approaching from a rear of the subject object, and
an alert system, wherein said alert system comprises at least one of a visual alert element and an audible alert element,
wherein, in operation,
said system motion sensing circuit is utilized to determine a location and respective velocity of said subject object,
said approaching object sensing system captures information associated with determining a distal relationship of each of said at least one monitored object respective to said subject object and a respective velocity of each of said at least one monitored object,
said microprocessor operating, in accordance with an analysis instruction set, utilizes said location and respective velocity of said subject object obtained by said system motion sensing circuit and said captured information associated with each of said at least one monitored object obtained by said approaching object sensing system to determine if the subject object and any of said at least one monitored object are on course suggesting a condition where a collision is impending,
when said microprocessor, operating in accordance with said analysis instruction set, determines said collision is impending, said microprocessor, operating in accordance with a user warning instruction set, activates said alert system to alert a user of said impending collision.

2. An encroaching vehicle monitoring and alerting system as recited in claim 1, wherein said approaching object sensing system includes a digital image acquisition device and said analysis instruction set includes a computer vision instruction set.

3. An encroaching vehicle monitoring and alerting system as recited in claim 1, wherein said Smartphone location sensing circuit is a Global Positioning System (GPS) circuit.

4. An encroaching vehicle monitoring and alerting system as recited in claim 1, wherein said alert system is integrated into said Smartphone.

5. An encroaching vehicle monitoring and alerting system as recited in claim 1, further comprising a forward oriented digital image acquisition device, the forward oriented digital image acquisition device is in signal communication with the microprocessor, wherein the forward oriented digital image acquisition device is oriented to acquire images of adjacent objects located forward of the subject object,
said instruction set further comprising steps of:
acquiring images of adjacent objects located forward of the subject object, and
recording said images of adjacent objects located forward of the subject object onto said digital memory device.

6. An encroaching vehicle monitoring and alerting system as recited in claim 1, further comprising a second approaching object sensing system secured to said subject object, the second approaching object sensing system is in signal communication with the microprocessor, wherein the second approaching object sensing system is oriented to sense said at least one monitored object approaching from a rear of the subject object,
said encroaching vehicle monitoring and alerting system further in operation:
in a condition where said microprocessor operating, in accordance with an analysis instruction set, determines the subject object and any of said at least one monitored object are on course suggesting a condition where a collision is impending, said microprocessor initiates operation of said second approaching object sensing system,
said second approaching object sensing system captures higher resolution information associated with determining a distal relationship of each of said at least one monitored object respective to said subject object and a respective velocity of each of said at least one monitored object,
said microprocessor operating, in accordance with a higher resolution analysis instruction set, utilizes said higher resolution location and respective velocity of said subject object obtained by said second system motion sensing circuit and said higher resolution captured information associated with each of said at least one monitored object obtained by said second approaching object sensing system to determine if the subject object and any of said at least one monitored object are on course suggesting the condition where a collision is impending,
when said microprocessor, operating in accordance with said higher resolution analysis instruction set, determines said collision is impending, said microprocessor, operating in accordance with said user warning instruction set, escalates said alert system to warn said user of an increased potential of said impending collision.

7. An encroaching vehicle monitoring and alerting system as recited in claim 1, wherein said approaching object sensing system includes a digital image acquisition device and said analysis instruction set includes a computer vision instruction set; and
wherein said second approaching object sensing system is one of a laser-based object sensing system, a radar-based object sensing system, and an acoustic-based object sensing system.

8. An encroaching vehicle monitoring and alerting system as recited in claim 1, said Smartphone further comprising at least one local proximity communication protocol circuit, wherein said at least one local proximity communication protocol circuit is one of Bluetooth, Wi-Fi, and Near Field Communications (NFC),
wherein said at least one local proximity communication protocol circuit provides communication from Smartphone to a receiving device carried by at least one adjacent vehicle, wherein said communication from Smartphone to a receiving device includes an alert to notify a drive of said at least one adjacent vehicle to be aware of the user of said encroaching vehicle monitoring and alerting system.

9. An encroaching vehicle monitoring and alerting system as recited in claim 1, said Smartphone further comprising an icon enabling a single contact dialer to access emergency e-911 support.

10. An encroaching vehicle monitoring and alerting system as recited in claim 1, said Smartphone further comprising a motion sensing device, wherein said motion sensing device can be utilized for at least one of:
activation and deactivation of said approaching object sensing system to optimize power conservation,
determination of said direction and velocity of said subject object,
determination of a collision,
determination of a collision and automatically dialing emergency e-911 to notify emergency personal of said collision.

11. An encroaching vehicle monitoring and alerting system as recited in claim 1, wherein said subject object is a bicycle.

12. An encroaching vehicle monitoring and alerting system, comprising:
a controller unit comprising:
a microprocessor, wherein said microprocessor is operated in accordance with an operational instruction set,
a digital memory device in signal communication with said microprocessor,
a system motion sensing circuit in signal communication with said microprocessor, wherein the system motion sensing circuit is used to determine a location and a motion of the controller unit, and
a housing containing said microprocessor and said system motion sensing system motion sensing circuit;
an approaching object sensing system secured to a subject object, the approaching object sensing system is in signal communication with the microprocessor, wherein the approaching object sensing system is oriented to sense at least one monitored object approaching from a rear of the subject object, and
an alert system, wherein said alert system comprises at least one of a visual alert element and an audible alert element,
wherein, in operation,
said system motion sensing circuit is utilized to determine a location and respective velocity of said subject object,
said approaching object sensing system captures information associated with determining a distal relationship of each of said at least one monitored object respective to said subject object and a respective velocity of each of said at least one monitored object,
said microprocessor operating, in accordance with an analysis instruction set, utilizes said location and respective velocity of said subject object obtained by said system motion sensing circuit and said captured information associated with each of said at least one monitored object obtained by said approaching object sensing system to determine if the subject object and any of said at least one monitored object are on course suggesting a condition where a collision is impending,
when said microprocessor, operating in accordance with said analysis instruction set, determines said collision is impending, said microprocessor, operating in accordance with a user warning instruction set, activates said alert system to alert a user of said impending collision.

13. An encroaching vehicle monitoring and alerting system as recited in claim 12, wherein said approaching object sensing system includes a digital image acquisition device and said analysis instruction set includes a computer vision instruction set.

14. An encroaching vehicle monitoring and alerting system as recited in claim 12, wherein said system motion sensing is a Global Positioning System (GPS) circuit.

15. An encroaching vehicle monitoring and alerting system as recited in claim 12, wherein said controller unit is a Smartphone.

16. An encroaching vehicle monitoring and alerting system as recited in claim 12, wherein said alert system is integrated into said controller unit.

17. An encroaching vehicle monitoring and alerting system as recited in claim 12, further comprising a forward oriented digital image acquisition device, the forward oriented digital image acquisition device is in signal communication with the microprocessor, wherein the forward oriented digital image acquisition device is oriented to acquire images of adjacent objects located forward of the subject object,
said instruction set further comprising steps of:
acquiring images of adjacent objects located forward of the subject object, and
recording said images of adjacent objects located forward of the subject object onto said digital memory device.

18. An encroaching vehicle monitoring and alerting system as recited in claim 12, further comprising a second approaching object sensing system secured to said subject object, the second approaching object sensing system is in signal communication with the microprocessor, wherein the second approaching object sensing system is oriented to sense said at least one monitored object approaching from a rear of the subject object,
said encroaching vehicle monitoring and alerting system further in operation:
in a condition where said microprocessor operating, in accordance with an analysis instruction set, determines the subject object and any of said at least one monitored object are on course suggesting a condition where a collision is impending, said microprocessor initiates operation of said second approaching object sensing system,
said second approaching object sensing system captures higher resolution information associated with determining a distal relationship of each of said at least one monitored object respective to said subject object and a respective velocity of each of said at least one monitored object,
said microprocessor operating, in accordance with a higher resolution analysis instruction set, utilizes said higher resolution location and respective velocity of said subject object obtained by said second system motion sensing circuit and said higher resolution captured information associated with each of said at least one monitored object obtained by said second approaching object sensing system to determine if the subject object and any of said at least one monitored object are on course suggesting the condition where a collision is impending,
when said microprocessor, operating in accordance with said higher resolution analysis instruction set, determines said collision is impending, said microprocessor, operating in accordance with said user warning instruction set, escalates said alert system to warn said user of an increased potential of said impending collision.

19. An encroaching vehicle monitoring and alerting system as recited in claim 12, wherein said approaching object sensing system includes a digital image acquisition device and said analysis instruction set includes a computer vision instruction set; and
wherein said second approaching object sensing system is one of a laser-based object sensing system, a radar-based object sensing system, and an acoustic-based object sensing system.

20. An encroaching vehicle monitoring and alerting system as recited in claim 12, wherein said subject object is a bicycle.
